(19) United States
(12) Patent Application Publication
(10) Pub. No.: US 2024/0115945 A1
(43) Pub. Date: Apr. 11, 2024

(54) NON-TRANSITORY COMPUTER READABLE MEDIUM, INFORMATION PROCESSING METHOD, AND INFORMATION PROCESSING SYSTEM

(71) Applicant: CYGAMES, INC., Tokyo (JP)

(72) Inventors: Hiroki Tsuda, Tokyo (JP); Jyun Endo, Tokyo (JP); Masahito Yonekura, Tokyo (JP); Reiji Suzumaru, Tokyo (JP)

(73) Assignee: CYGAMES, INC., Tokyo (JP)

(21) Appl. No.: 18/391,066

(22) Filed: Dec. 20, 2023

Related U.S. Application Data
(63) Continuation of application No. PCT/JP22/21934, filed on May 30, 2022.

(30) Foreign Application Priority Data
Jun. 23, 2021 (JP) 2021-103724

(51) Int. Cl. A63F 13/53; A63F 13/45; A63F 13/69; A63F 13/822

(52) U.S. Cl. CPC A63F 13/53; A63F 13/45; A63F 13/69; A63F 13/822

(57) ABSTRACT

A non-transitory computer readable medium stores a program causing a computer to execute: allowing a player to acquire a privilege within an upper-limit number of times per prescribed period, for each of a plurality of missions that the player can accomplish; giving, when the player accomplishes one of the plurality of missions and a number of times that the player has acquired the privilege within the prescribed period through the accomplished mission is less than the upper-limit number of times, the privilege to the player; and generating a list by extracting a plurality of first missions, among the plurality of missions, with which the number of times that the player has acquired the privilege within the prescribed period is less than the upper-limit number of times.

### CROSS REFERENCE TO RELATED APPLICATIONS

This application is a continuation application of International Application No. PCT/JP2022/021934, filed on May 30, 2022, which claims priority to Japanese Patent Application No. 2021-103724, filed on Jun. 23, 2021, the entire contents of which are incorporated by reference herein.

### BACKGROUND ART

### Technical Field

The present invention relates to information processing programs, information processing methods, and information processing systems.

In a type of games that has hitherto been known, a quest is provided, in which a player plays a battle against enemy characters by using a party formed by the player. In this type of game, there are cases where a plurality of quests involving different enemy characters or having different difficulty levels are provided. The player can select and play one of the plurality of quests.

Patent Literature 1 discloses a game in which what are called daily missions are set for each player. The player can acquire prescribed privileges by accomplishing the daily missions. The right to acquiring the privileges by accomplishing the daily missions is reset every day at the same timing. Therefore, the player can repeatedly acquire the privileges by accomplishing the daily missions every day. As such, the daily missions give a motivation for the player to play the game.

### CITATION LIST

### Patent Literature

Patent Literature 1: JP 2020-103839 A

### SUMMARY OF INVENTION

### Technical Problem

In the case where a privilege is repeatedly set per prescribed period, like the daily missions described above, the player is given a sense of duty that the player has to accomplish all the daily missions. Furthermore, if a large number of daily missions are set, the player has to perform laborious operations, which might compromise the motivation for playing the game.

It is an object of the present invention to provide an information processing program, an information processing method, and an information processing system that make it possible to enhance the motivation for playing through an improvement in the ease of operation.

### Solution to Problem

In order to solve the problem described above, an information processing program causes a computer to carry out:
a process of making it possible to acquire a privilege, within an upper-limit number of times per prescribed period, for each of a plurality of missions that a player can accomplish;
a process of giving the privilege to the player in the case where one of the missions through which it is possible to acquire the privilege is accomplished, on condition that the number of times of the acquisition of the privilege within one duration of the prescribed period is less than the upper-limit number of times; and
a process of generating a list by extracting the missions with which the number of times of the acquisition of the privilege within the prescribed period is less than the upper-limit number of times.

Furthermore, the computer may be further caused to carry out:
a process of letting the player sequentially execute the plurality of missions extracted in the list.

Furthermore, the missions may include missions for which the player can select a normal play and a skip play and that can be accomplished via both the normal play and the skip play, where the skip play is a play in which processing is at least partially omitted compared with the normal play, and
the information processing program may further cause the computer to carry out:
a process of executing the plurality of missions extracted in the list via the skip play.

Furthermore, the computer may be further caused to carry out:
a process of allowing the player to select one of a plurality of quests each classified into one of the groups and having a clearing condition set therefor;
a process of executing the quest selected by the player on the basis of information set by the player or an operation input by the player; and
a process of displaying the quests extracted in the list for the individual groups,
the missions may include the satisfaction of the clearing conditions for the quests, and
the privilege that can be acquired per the prescribed period may vary among the individual groups into which the quests are classified.

In order to solve the problem described above, an information processing method is an information processing method that is carried out by one or more computers, the information processing method including:
a process of making it possible to acquire a privilege, within an upper-limit number of times per prescribed period, for each of a plurality of missions that a player can accomplish;
a process of giving the privilege to the player in the case where one of the missions through which it is possible to acquire the privilege is accomplished, on condition that the number of times of the acquisition of the privilege within one duration of the prescribed period is less than the upper-limit number of times; and
a process of generating a list by extracting the missions with which the number of times of the acquisition of the privilege within the prescribed period is less than the upper-limit number of times.

In order to solve the problem described above, an information processing system is an information processing system that is provided with one or more computers,
wherein the computers carry out:
a process of making it possible to acquire a privilege, within an upper-limit number of times per prescribed period, for each of a plurality of missions that a player can accomplish;
a process of giving the privilege to the player in the case where one of the missions through which it is possible to acquire the privilege is accomplished, on condition that the number of times of the acquisition of the privilege within one duration of the prescribed period is less than the upper-limit number of times; and
a process of generating a list by extracting the missions with which the number of times of the acquisition of the privilege within the prescribed period is less than the upper-limit number of times.

### Effects of Disclosure

The present invention makes it possible to enhance the motivation for playing through an improvement in the ease of operation.

### BRIEF DESCRIPTION OF DRAWINGS

FIG. 1 is an explanatory illustration schematically showing the configuration of an information processing system.

FIG. 2A is a diagram for explaining the hardware configuration of a player terminal.

FIG. 2B is a diagram for explaining the hardware configuration of a server.

FIGS. 3A and 3B are illustrations for explaining example party formation screens.

FIG. 4A is an illustration for explaining an example group selection screen.

FIG. 4B is an illustration for explaining an example difficulty-level selection screen.

FIG. 4C is an illustration for explaining an example play-mode selection screen.

FIG. 4D is an illustration for explaining an example party selection screen.

FIG. 5A is an illustration for explaining an example quest start screen.

FIG. 5B is an illustration for explaining an example battle game screen during a battle game via solo-play.

FIG. 5C is an illustration for explaining an example of skill gauges and a dragonization gauge.

FIG. 5D is an illustration for explaining dragonization.

FIG. 6A is an illustration for explaining an example battle game screen for the case of a victory for a player.

FIG. 6B is an illustration for explaining an example reward screen.

FIG. 7 is a figure for explaining an example of reward tables.

FIG. 8 is a figure for explaining an example of quests constituting daily missions.

FIG. 9 is a figure for explaining an example of additional rewards.

FIG. 10A is a first illustration for explaining an example batch-skipping-function setting tab.

FIG. 10B is a second illustration for explaining an example batch-skipping-function setting tab.

FIG. 10C is an illustration for explaining an example party selection screen at the time of batch skipping.

FIG. 11A is an illustration for explaining an example ticket setting screen.

FIG. 11B is an illustration for explaining an example first aggregated reward screen.

FIG. 11C is an illustration for explaining an example additional reward screen.

FIG. 11D is an illustration for explaining an example second aggregated reward screen.

FIG. 12A is a diagram for explaining the configuration of a memory in the player terminal, as well as the functions thereof as a computer.

FIG. 12B is a diagram for explaining the configuration of a memory in the server, as well as the functions thereof as a computer.

FIG. 13 is a sequence chart for explaining basic processes at the player terminal and the server.

FIG. 14 is a flowchart for explaining a log-in process at the server.

FIG. 15 is a flowchart for explaining a list generation process at the player terminal.

FIG. 16 is a flowchart for explaining a solo-play execution process at the player terminal.

FIG. 17 is a flowchart for explaining a reward lottery process at the server.

FIG. 18 is a second sequence chart at the player terminal and the server.

FIG. 19 is a flowchart for explaining a skipping process at the server.

FIG. 20 is a third sequence chart at the player terminal and the server.

FIG. 21 is a flowchart for explaining a batch skipping process at the server.

### DESCRIPTION OF EMBODIMENTS

An aspect of an embodiment of the present invention will be described below in detail with reference to the accompanying drawings. The numerical values, etc. given in this embodiment are merely examples for facilitating understanding, and do not limit the present invention unless otherwise specifically mentioned. In the present description and the drawings, elements having substantially the same functions and configurations have the same reference signs attached thereto and are not described repeatedly, and elements that are not directly relevant to the present invention are not shown.

(Overall Configuration of Information Processing System S)

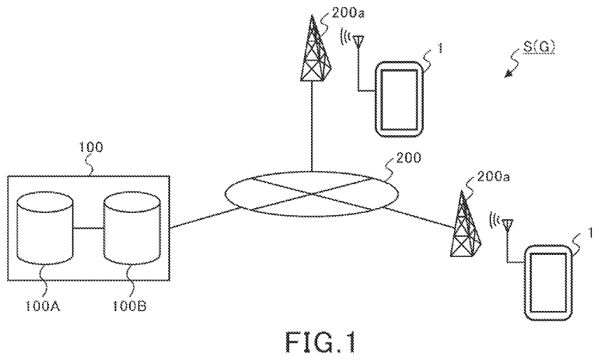

FIG. 1 is an explanatory illustration schematically showing the configuration of an information processing system S. The information processing system S is what is called a client-server system including player terminals 1, a server 100, and a communication network 200 having communication base stations 200a.

In the information processing system S in this embodiment, the player terminals 1 and the server 100 function as a game device G. The player terminals 1 and the server 100 individually share roles for controlling the proceeding of a game, and it becomes possible to proceed with the game through cooperation between the player terminals 1 and the server 100.

The player terminals 1 can establish communication with the server 100 via the communication network 200. The player terminals 1 include a wide range of electronic appliances that are capable of communicatively connecting to the server 100 in a wireless or wired manner. Examples of the player terminals 1 include smartphones, mobile phones, tablet devices, personal computers, and game machines. This embodiment will be described in the context of a case where smartphones are used as the player terminals 1.

The server 100 is communicatively connected to the plurality of player terminals 1. The server 100 includes a management server 100A and a battle game server 100B. The management server 100A accumulates various kinds of information for each player who plays the game. Hereinafter, the information accumulated for each player will be referred to as player information. Furthermore, the management server 100A mainly carries out processing such as updating the accumulated player information and allowing the player terminals 1 to download images and various kinds of information, on the basis of operations input from the player terminals 1.

Furthermore, the information processing system S realizes a battle game in which a plurality of players cooperatively play battles against enemy characters. The battle game server 100B mainly carries out processing for controlling the proceeding of a battle game, such as creating a room for carrying out the battle game, assigning players to the room, sending information to and receiving information from a plurality of player terminals 1 connected to the room, and synchronizing the plurality of player terminals 1.

Hereinafter, of the games provided by the information processing system S, battle games will be referred to as in-games, and games other than battle games will be referred to as out-games. The management server 100A mainly carries out processing relating to out-games, and the battle game server 100B mainly carries out processing relating to in-games.

The communication base stations 200a are connected to the communication network 200, and send information to and receive information from the player terminals 1 in a wireless manner. The communication network 200 is implemented by a mobile phone network, an Internet network, a local area network (LAN), a special circuit, or the like, and realizes wireless or wired communicative connection between the player terminals 1 and the server 100.

(Hardware configurations of player terminals 1 and server 100)

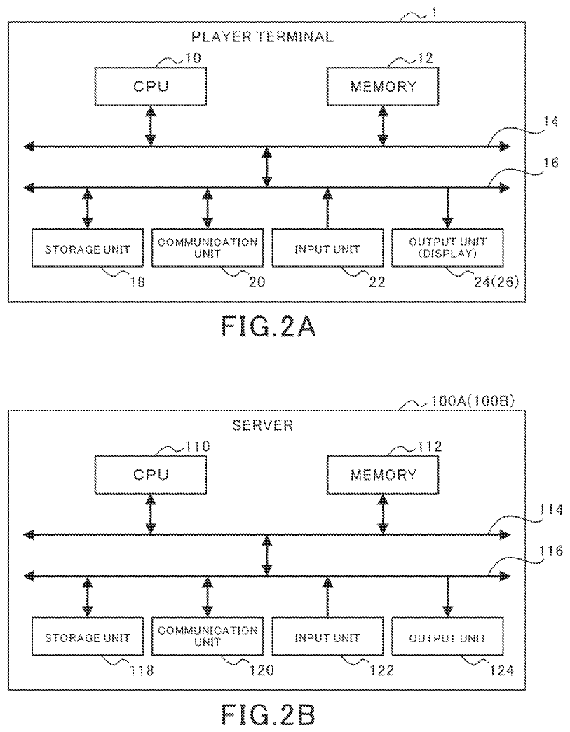

FIG. 2A is a diagram for explaining the hardware configuration of a player terminal 1. Furthermore, FIG. 2B is a diagram for explaining the hardware configuration of the server 100. As shown in FIG. 2A, the player terminal 1 is configured to include one or more central processing units (CPUs) 10, a memory 12, a bus 14, an input/output interface 16, a storage unit 18, a communication unit 20, an input unit 22, and an output unit 24.

Furthermore, as shown in FIG. 2B, the management server 100A and the battle game server 100B are configured to include one or more CPUs 110, a memory 112, a bus 114, an input/output interface 116, a storage unit 118, a communication unit 120, an input unit 122, and an output unit 124.

Note that the configurations and functions of the CPUs 110, the memory 112, the bus 114, the input/output interface 116, the storage unit 118, the communication unit 120, the input unit 122, and the output unit 124 of the management server 100A and the battle game server 100B are substantially the same as those of the CPUs 10, the memory 12, the bus 14, the input/output interface 16, the storage unit 18, the communication unit 20, the input unit 22, and the output unit 24 of the player terminal 1, respectively. Therefore, the following description will be directed to the hardware configuration of the player terminal 1, while omitting descriptions of the management server 100A and the battle game server 100B.

The CPUs 10 run a program stored in the memory 12 to control the proceeding of the game. The memory 12 is configured of a read only memory (ROM) or a random access memory (RAM), and stores the program and various kinds of data needed for controlling the proceeding of the game. The memory 12 is connected to the CPU 10 via the bus 14.

The input/output interface 16 is connected to the bus 14. The storage unit 18, the communication unit 20, the input unit 22, and the output unit 24 are connected to the input/output interface 16.

The storage unit 18 is configured of a semiconductor memory such as a dynamic random access memory (DRAM), and stores various kinds of programs and data. In the player terminal 1, the programs and data stored in the storage unit 18 are loaded into the memory 12 (RAM) by the CPUs 10.

The communication unit 20 is communicatively connected to a communication base station 200a in a wireless manner, and sends information to and receives information from the server 100 via the communication network 200, such as various kinds of data and programs. In the player terminal 1, programs, etc. received from the server 100 are stored in the memory 12 or the storage unit 18.

The input unit 22 is configured of a unit via which player operations are accepted, such as a touch panel, buttons, a keyboard, a mouse, a cross keypad, or an analog controller. Alternatively, the input unit 22 may be a special controller provided at the player terminal 1 or externally connected to the player terminal 1. Yet alternatively, the input unit 22 may be configured of an acceleration sensor that detects tilting or movement of the player terminal 1 or a microphone that detects player's voice. That is, examples of the input unit 22 include a wide range of devices that enable the input of player's intents in distinguishable manners.

The output unit 24 is configured to include a display device and a speaker. Note that the output unit 24 may be a device externally connected to the player terminal 1. In this embodiment, the player terminal 1 includes a display 26 as the output unit 24 and includes a touch panel as the input unit 22, the touch panel being provided so as to be stacked on the display 26.

(Game Specifics)

Next, the specifics of the games provided by the information processing system S or a game device G in this embodiment will be described in the context of an example. Each player can own characters acquired through lotteries, called gacha, as well as characters distributed from the administrator side. The player can form a party by selecting a plurality of (four here) characters from the characters owned by the player (hereinafter referred to as owned characters). Furthermore, the player can play battle games in which the player plays battles against enemy characters by using the party formed.

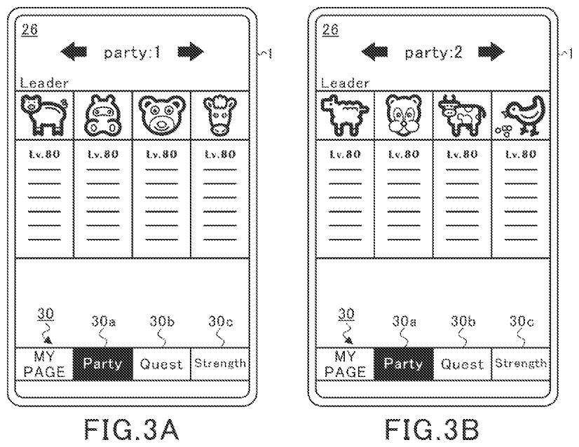

FIGS. 3A and 3B are illustrations for explaining example party formation screens. During an out-game, a menu bar 30 is displayed in a lower part of the display 26. In the menu bar 30, a plurality of selecting parts, including a party-formation selecting part 30a, a quest-selection operating part 30b, and an enhancement selecting part 30c, are provided. When the party-formation selecting part 30a is tapped, a party formation screen is displayed, as shown in FIG. 3A. In the party formation screen, party information concerning a party formed by the player is displayed.

The player registers a party by selecting four owned characters. In the party formation screen, information concerning the characters constituting the registered party (hereinafter referred to as party forming characters) is displayed as arrayed side by side. Specifically, the player can register four owned characters in a party as a first party forming character, a second party forming character, a third party forming character, and a fourth party forming character. In the party formation screen, information concerning the first party forming character, the second party forming character, the third party forming character, and the fourth party forming character is displayed in this order from the left.

When the region where information concerning one of the party forming characters is tapped to select that party forming character, an owned character list screen, which is not shown, is displayed. The player can replace the party forming character by selecting one of the owned characters in the owned character list screen.

Note that the first party forming character displayed leftmost in the party formation screen is registered as the leader of the party. In the party formation screen, the leader can be changed, for example, by tapping the first party forming character and then tapping another party forming character. That is, the player can register the party forming character that serves as the leader in the party formation screen.

Furthermore, the player can register a plurality of parties in advance. Here, the player can register nine parties at most. In the party formation screen, when a flick operation in the horizontal direction is input, the party information that is displayed is switched. For example, when a leftward flick operation is input in the state where party information concerning a first party is displayed, as shown in FIG. 3A, party information concerning a second party is displayed, as shown in FIG. 3B.

The party whose party information is displayed in the party formation screen is registered as a party currently selected by the player. Suppose, for example, that another selecting part in the menu bar 30 is tapped in the state where the party information concerning the second party is displayed, as shown in FIG. 3B, whereby the displaying of the party formation screen is terminated. In this case, the second party, whose party information was displayed when the party formation screen was closed, is registered as the currently selected party.

Note that each character has set therefor parameters such as hit points (hereinafter referred to as HPs) and an attacking ability. The player can raise owned characters, and can enhance various kinds of parameters by advancing the levels of owned characters. In the party information displayed in the party formation screen, the parameters of the individual party forming characters are displayed.

Furthermore, although not described in detail, in the party formation screen, the player can equip each party forming character with a weapon and a dragon. Furthermore, the player can set an item of equipment called crest to a weapon that a party forming character is equipped with. A crest has set therefor utility information for advantageously proceeding with a battle game, such as enhancing the attacking ability of the party forming character. By providing equipment, the player can advantageously proceed with a battle game; for example, the player can increase parameters, such as the HPs and the attacking abilities, of the party forming characters participating in a battle game (hereinafter referred to as participating characters), or can decrease parameters of enemy characters.

Furthermore, a dragon is a character into which a participating character can transform itself. When a prescribed condition is satisfied during a battle game, only for a limited period, the player can transform a participating character into the dragon that the participating character is equipped with. Since a dragon can give great damage to enemy characters, it becomes possible to advantageously proceed with a battle game by transforming a participating character into a dragon.

Furthermore, each owned character and each item of equipment has skills set therefor in advance. A skill refers to a special ability that becomes available when a prescribed condition is satisfied during a battle game. The player can advantageously proceed with a battle game by using a skill. For example, the player can change various kinds of parameters by using skills, such as giving damage to enemy characters, increasing the attacking abilities of participating characters, recovering the HPs of participating characters, and decreasing the attacking abilities of enemy characters. In the party information displayed in the party formation screen, equipment information concerning the equipment and dragons of the individual party forming characters, as well as information concerning the skills, are displayed.

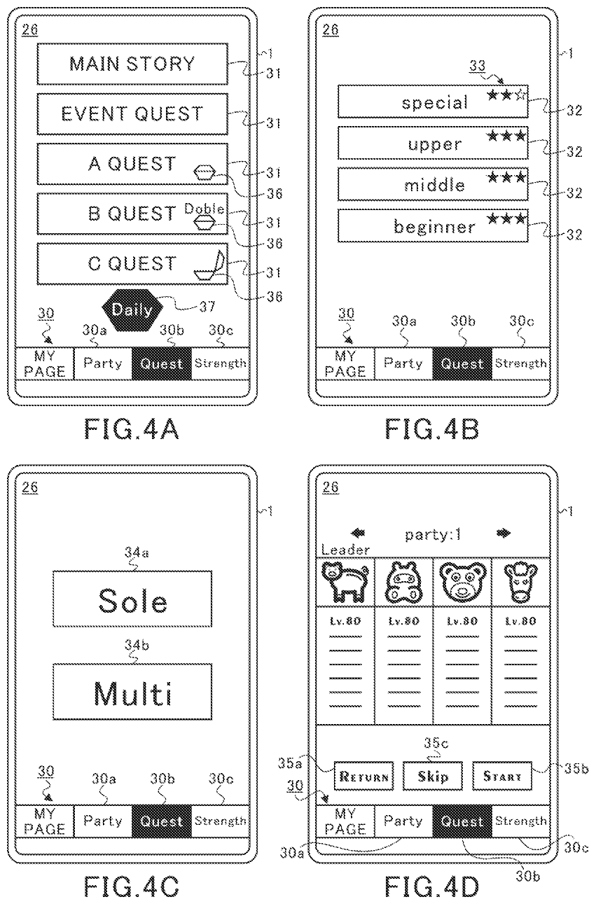

FIG. 4A is an illustration for explaining an example group selection screen. FIG. 4B is an illustration for explaining an example difficulty-level selection screen. FIG. 4C is an illustration for explaining an example play-mode selection screen. FIG. 4D is an illustration for explaining an example party selection screen. When the quest-selection operating part 30b in the menu bar 30 is tapped, the group selection screen shown in FIG. 4A is displayed. Here, quests refer to the kinds of battle games, and can be considered as the content of battle games.

In this embodiment, each quest has set therefor a clearing condition. Example clearing conditions that are set to individual quests include defeating the boss character within a prescribed period and annihilating all the enemy characters within a prescribed period. When a clearing condition is satisfied, the corresponding quest is cleared, and a reward is given to the player.

Here, each quest is classified into one of a plurality of groups. Hereinafter, of the quest groups, a main story, event quests, group A, group B, group C, and group D will be described. However, quest groups are not limited to these groups, and a large number of other groups are further provided.

For example, chapters 1 to 20 are provided in the main story, with about five to ten kinds of quests belonging to each of the chapters. For example, six kinds of quests, namely, quests 1-1 to 1-6, belong to chapter 1 of the main story, and ten kinds of quests, namely, quests 10-1 to 10-10, belong to chapter 10 of the main story. The player can play the quests classified into the main story in a prescribed order. Specifically, the player can first play the quests belonging to chapter 1.

At this time, the player has to sequentially clear quests 1-1 to 1-6. Therefore, when quest 1-1 of chapter 1 is cleared, quest 1-2 becomes released, and it becomes possible for the player to play quest 1-2. Then, when the player has cleared quest 1-6, in other words, when the player has cleared all the quests belonging to chapter 1, chapter 2 becomes released.

As described above, when the player has cleared all the quests belonging to each chapter, it becomes possible for the player to play the quests belonging to the next chapter. Note that the difficulty levels of the quests classified into the main story gradually become higher from chapter 1 to chapter 20. Similarly, with quests belonging to the same chapter, quests that are released relatively later in the same chapter have higher difficulty levels. Furthermore, there are cases where quests that are classified into the main story are added regularly or irregularly. In this case, although new chapters are basically added, alternatively, quests belonging to existing chapters may be added.

Event quests constitute a group into which quests for events that are held irregularly are classified. A plurality of quests involving different enemy characters and having different difficulty levels are classified into event quests. An event that is classified into event quests can be played only during a period in which the event is held. The period in which an event is held is, for example, about from one week to one month.

Group A is a group into which quests directed to the acquisition of raising items are classified. A raising item is an item that can be used by selecting an owned character in an out-game. When a raising item is used, the experience value of the selected owned character is increased. When the experience value is increased, the level of the owned character is advanced. Therefore, it can be said that a raised item is an item for advancing the level of an owned character. When the level of an owned character is advanced, a parameter of the owned character is advanced.

When a quest classified into group A is cleared, raising items are given as a reward. The number of raising items that are given at this time is greater than the number of raising items that are given in the case where other quests are cleared. Therefore, it can be said that quests classified into group A are played mainly for the purpose of acquiring raising items.

Note that four kinds of quests, namely, beginner, middle, upper, and special, are classified into group A. These four kinds of quests have individually different difficulty levels: the middle is more difficult than the beginner, the upper is more difficult than the middle, and the special is more difficult than the upper. Furthermore, the reward that is given when a quest is cleared becomes greater as the difficulty level thereof becomes higher.

Group B is a group into which quests directed to the acquisition of an in-game currency are classified. The in-game currency is consumed, for example, when generating or enhancing a weapon or in exchange for an item in an out-game. When a quest classified into group B is cleared, a sum of the in-game currency is given as a reward. The sum of the in-game currency that is given at this time is greater than the sums of the in-game currency that are given when other quests are cleared. Therefore, it can be said that quests classified into group B are played mainly for the purpose of the acquisition of the in-game currency.

Note that four kinds of quests, namely, beginner, middle, upper, and special, are classified into group B. These four kinds of quests have individually different difficulty levels: the middle is more difficult than the beginner, the upper is more difficult than the middle, and the special is more difficult than the upper. Furthermore, the reward that is given when a quest is cleared becomes greater as the difficulty level thereof becomes higher.

Group C is a group into which quests directed to the acquisition of character enhancing items are classified. A character enhancing item is an item that can be used by selecting an owned character in an out-game. When a character enhancing item is used, a specific parameter of the selected owned character is advanced. Therefore, it can be said that a character enhancing item is an item for enhancing a parameter of an owned character.

Note that, although not described in detail, owned characters have attributes set therefor. Here, five attributes, namely, “fire”, “wind”, “water”, “light”, and “darkness”, are provided. Furthermore, among enemy characters, there are character having one of the abovementioned five attributes set therefore. Depending on the combination of the attributes of owned characters and enemy characters, it becomes possible to advantageously proceed with a quest. Therefore, the player has to form a party in consideration of the attributes of owned characters on a per-quest basis.

Furthermore, character enhancing items also have one of the abovementioned five attributes set therefor, and character enhancing items that are applicable to an owned character are limited to character enhancing items having the same attribute as the owned character.

Note that quests in group C are classified into the abovementioned five attributes, and three kinds of quests, namely, beginner, middle, and upper are classified into each of the attributes. Therefore, fifteen kinds of quests are classified into group C. The three kinds of quests classified into each of the attributes have individually different difficulty levels: the middle is more difficult than the beginner, and the upper is more difficult than the middle. Furthermore, the reward that is given when a quest is cleared becomes greater as the difficulty level thereof becomes higher.

Furthermore, the reward that is given when a quest in group C is cleared varies depending on the attribute into which the quest is classified. For example, a quest classified into the attribute “fire” in group C is cleared, a character enhancing item having the attribute “fire” is given. As such, when a quest classified into group C is cleared, a character enhancing item having the same attribute as the attribute into which the quest is classified is given. Therefore, the player can acquire a desired character enhancing item by selecting and playing a quest classified into group C.

Group D is a group into which quests directed to the acquisition of dragon-related items are classified. A plurality of kinds of dragon-related items are provided. One of the dragon-related items is an item that can be used by selecting an owned dragon in an out-game. When this item is used, the level of the selected dragon is advanced. When the level of the dragon is advanced, a parameter of the dragon is advanced.

Furthermore, similarly to the character enhancing items described above, there are also dragon-related items for enhancing parameters of owned characters. Therefore, it can be said that dragon-related items are items for enhancing owned characters or owned dragons.

Note that as dragon-related items, items having one of the abovementioned five attributes set therefor and items not having attributes are provided. For example, dragon-related items that are applicable to an owned character are limited to items having the same attribute as the owned character. Meanwhile, dragon-related items that are used for advancing the levels of dragons do not have attributes.

Note that quests in group D are classified into the abovementioned five attributes, and four kinds of quests, namely, beginner, middle, upper, and special are classified into each of the attributes. Therefore, twenty kinds of quests are classified into group D. Similarly to group A and group B described above, with the four kinds of quests classified into each of the attributes, the beginner has the lowest difficulty level, and special has the highest difficulty level. Furthermore, the reward that is given when a quest is cleared becomes greater as the difficulty level thereof becomes higher.

Furthermore, the reward that is given when a quest in group D is cleared varies depending on the attribute into which the quest is classified. For example, a quest classified into the attribute “water” in group D is cleared, a dragon-related item having the attribute “water” is given. Therefore, the player can acquire a desired dragon-related item by selecting and playing a quest classified into group D. Note that dragon-related items not having attributes are given commonly irrespective of the attributes into which quests are classified.

In the group selection screen shown in FIG. 4A, a plurality of group-selection operating parts 31 are displayed. The group-selection operating parts 31 are provided for the individual quest groups. In the group selection screen, as shown in FIG. 4A, the group-selection operating parts 31 for the main story, event quest, group A, group B, and group C are displayed in this order from the top. When a flick operation in the upward direction is input in the group selection screen, the group-selection operating parts 31 are scrolled, and the group-selection operating parts 31 for group D and other groups are displayed.

The player can select one of the groups by tapping one of the group-selection operating parts 31. For example, when the group-selection operating part 31 for group A is tapped in the group selection screen, the difficulty-level selection screen shown in FIG. 4B is displayed. In the difficulty-level selection screen, a plurality of difficulty-level selection operating parts 32 are displayed. The difficulty-level selection operating parts 32 are provided individually for the difficulty levels of the quests classified into a group selected earlier.

As described above, four quests, namely, beginner, middle, upper, and special, are classified into group A. Therefore, in the case where group A is selected, as shown in FIG. 4B, four difficulty-level selection operating parts 32 are displayed in the difficulty-level selection screen.

Note that clearing information 33 is displayed in each of the difficulty-level selection operating parts 32. The clearing information 33 is constituted of three stars, and the clearing status of the corresponding quest is reported in the form of the number of black-painted stars in the clearing information 33. Specifically, as described earlier, each quest has a clearing condition set therefor. At this time, for example, one star is acquired in the case where a quest is cleared without any of the four participating characters in the party being defeated. Furthermore, one star is acquired in the case where a quest is cleared without two or more of the four participating characters being defeated. Furthermore, for example, one star is acquired also in the case where a quest is cleared without using a continuation or the like. As such, the clearing information 33 displayed in each of the difficulty-level selection operating parts 32 makes it possible for the player to recognize the clearing status of the corresponding quest.

Furthermore, when one of the difficulty-level selection operating parts 32 is tapped in the difficulty-level selection screen, the play-mode selection screen shown in FIG. 4C is displayed. In the play-mode selection screen, a solo-play selecting part 34a and a multi-play selecting part 34b are displayed. For each quest, the player can select either solo-play, in which the player operating the player terminal 1 plays a game alone, or multi-play, in which a plurality of player terminals 1 are communicatively connected and the players cooperatively play a game.

Note that although the description here will be given in the context of quests for which it is possible to select both solo-play and multi-play, quests for which only solo-play is possible and quests for which only multi-play is possible may be provided. The player can select solo-play as the play mode by tapping the solo-play selecting part 34a, and can select multi-play as the play mode by tapping the multi-play selecting part 34b. In the following description of the specifics of a battle game, the battle game via solo-play will be described.

(Solo-Play)

When the solo-play selecting part 34a is tapped in the play-mode selection screen, the party selection screen shown in FIG. 4D is displayed. In the party selection screen, party information is displayed as shown in the figure. At the time of transition to the party selection screen, party information concerning the registered currently selected party is displayed. In the party selection screen, the player can switch the party information displayed on the display 26, for example, by performing a flick operation in the horizontal direction. When the party information is switched in the party selection screen, the registered currently selected party is also changed. That is, the player can change the currently selected party in the party selection screen.

Furthermore, in the party selection screen, a return button 35a, a start button 35b, and a skip button 35c are displayed. When the return button 35a is tapped, a screen transition occurs from the party selection screen shown in FIG. 4D to the play-mode selection screen shown in FIG. 4C. Meanwhile, when the start button 35b is tapped, a battle game via solo-play using the registered currently selected party is started.

Furthermore, when the skip button 35c is tapped, skip processing for skipping a battle game is performed. In this skip processing, without the player having to play a battle game, it is assumed that the selected quest is cleared, and a reward is given to the player. Hereinafter, a quest play via skip processing will be referred to as a skip play, and a quest play not involving skip processing will be referred to as a normal play. In this embodiment, the player can select and execute a normal play or a skip play, in which processing is skipped at least partially compared with a normal play.

In order to select a skip play, however, it is necessary that three black-painted stars are displayed in the clearing information 33 described above. In other words, each quest has a skipping condition set therefor, and the player can select a skip play only for a quest that satisfies the skipping condition. Here, each quest has set therefor, as a skipping condition, the condition that the quest is cleared without any of the participating characters in the party being defeated and without using a continuation, a respawn, which will be described later, or the like. In the case where the quest selected by the player does not satisfy the skipping condition, a player's operation is not accepted in the party selection screen; for example, the skip button 35c is grayed out.

Furthermore, in order to select a skip play, a skipping ticket is required. In other words, the player can select a skip play by consuming a skipping ticket. For example, a skipping ticket is distributed to the player when the player logs in for the first time during a prescribed period or as a reward for clearing a quest.

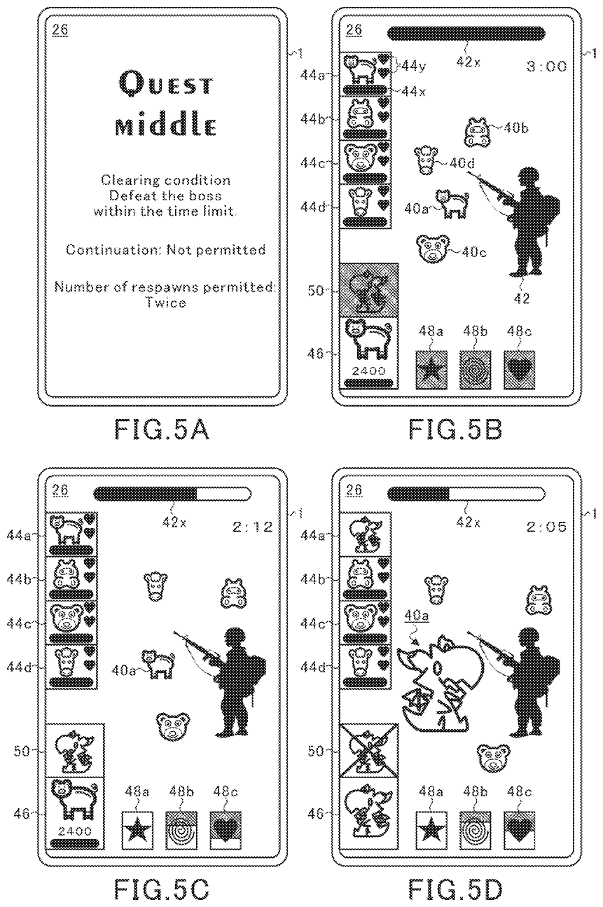

FIG. 5A is an illustration for explaining an example quest start screen. A battle game is started when the start button 35b is tapped in the party selection screen 35b. When the battle game is started, the quest start screen is displayed, as shown in FIG. 5A. In the quest start screen, quest information, which is information concerning the quest being started, i.e., the battle game, is displayed. Here, as the quest information, a clearing condition for clearing the quest, whether or not continuation is permitted, and the number of respawns permitted are displayed.

Furthermore, each quest has set therefor whether or not continuation is permitted, as well as the number of continuations permitted. In this embodiment, in a battle game via solo-play, the player is defeated on condition that all the participating characters have entered a continuation disabled state, i.e., on condition that all the participating characters have been annihilated.

Here, the state in which the HPs of a participating character have become zero is defined as a continuation disabled state, and the state in which the HPs of a participating character have not become zero is defined as a continuation enabled state. Participating characters in the continuation enabled state perform actions on the basis of operations input to the player terminal 1 or on the basis of computer control, while participating characters in the continuation disabled state are disabled from performing actions.

In a continuable quest, in the case where all the participating characters have been annihilated, the player can select whether or not to continue the quest by consuming a prescribed sum of the in-game currency. When the player executes continuation, all the participating characters are restored from the continuation disabled state to the continuation enabled state, which makes it possible to continue the quest.

Furthermore, each quest has set therefor whether or not respawns are permitted and the number of respawns permitted. Here, a “respawn” in a battle game refers to restoring a participating character that has entered the continuation disabled state into the continuation enabled state in the case where a respawn condition is satisfied, similarly to the continuation described above. In a battle game via solo-play, each participating character has set therefor the number of respawns permitted, and it is determined that the respawn condition is satisfied in the case where all the participating characters have been annihilated and there is a participating character for which one or more respawns are permitted.

That is, in a quest in which respawns are permitted, even if all the participating characters have been annihilated, a defeat for the player is avoided if there is a participating character for which one or more respawns are permitted. Meanwhile, when all the participating characters have been annihilated, in the case where there is no participating character for which one or more respawns are allowed and a continuation is not executed or a continuation cannot be executed, a defeat for the player is determined at that timing.

FIG. 5B is an illustration for explaining an example battle game screen during a battle game via solo-play. FIG. 5C is an illustration for explaining an example of skill gauges 48a, 48b, and 48c as well as a dragonization gauge 50. FIG. 5D is an illustration for explaining dragonization. When a battle game is started and the quest start screen shown in FIG. 5A is displayed for a prescribed period, the battle game screen is displayed, as shown in FIG. 5B. In the battle game screen, a virtual game field is displayed, and a first participating character 40a, a second participating character 40b, a third participating character 40c, and a fourth participating character 40d, which are participating characters, as well as a boss character 42, are displayed in the game field. Note that the first participating character 40a to the fourth participating character 40d are the first party forming character to the fourth party forming character, respectively. Therefore, the first participating character 40a is a participating character registered as the leader.

In a battle game, one of the four participating characters is set as an operable character, which can be operated by the player. That is, the operable character is a participating character that operates on the basis of operations input to the player terminal 1. When a battle game is started, the participating character registered as the leader, i.e., the first participating character 40a, is set as the operable character.

The player can cause the operable character to perform an attacking action by tapping the region where the game field is displayed in the battle game screen, or can move the operable character in the operated direction by performing a slide operation or a flick operation. Meanwhile, the three participating characters, not including the operable character, perform actions on the basis of computer control. Hereinafter, participating characters that perform actions on the basis of computer control will be referred to as non-operated characters.

The player can change the operable character during a battle game. Specifically, in the battle game screen, a first character-information displaying part 44a, a second character-information displaying part 44b, a third character-information displaying part 44c, and a fourth character-information displaying part 44d are displayed as character-information displaying parts. The first character-information displaying part 44a to the fourth character-information displaying part 44d respectively correspond to the first participating character 40a to the fourth participating character 40d, and display information concerning the corresponding participating characters.

The player can switch the operable character by tapping one of the character-information displaying parts. For example, when the fourth character-information displaying part 44d is tapped in the state where the first participating character 40a is set as the operable character, the fourth participating character 40d is set as the operable character, and the first participating character 40a is set as a non-operated character. This makes it possible for the player to operate the fourth participating character 40d by inputting operations to the player terminal 1.

Note that in each of the character-information displaying parts, a character image is displayed so that the corresponding participating character can be identified, and an HP meter 44x indicating the HPs of the corresponding participating character is displayed. Furthermore, respawn information 44y indicating the number of respawns permitted of the corresponding participating character is displayed in each of the character-information displaying parts. Here, the same number of heart marks as the number of respawns permitted are displayed as the respawn information 44y.

Furthermore, in a lower left part of the battle game screen, an operable-character displaying part 46 is displayed separately from the character-information displaying parts. The operable-character displaying part 46 serves to report the participating character currently set as the operable character, as well as the HPs of the operable character.

Furthermore, three skill gauges 48a, 48b, and 48c are displayed in the battle game screen. As described earlier, characters and equipment have available skills set therefor in advance. The skill gauges 48a, 48b, and 48c report the specifics of the skills available to the operable character, whether or not the use of the skills is permitted, and the gauge values remaining before the skills become available.

Specifically, each skill has set therefor in advance a gauge value that is necessary for the skill to become available. The gauge values of the skill gauges 48a, 48b, and 48c increase, for example, in accordance with the values of damage given to the boss character 42 or the like by the operable character. In the state where a gauge value is less than the necessary gauge value, the corresponding skill is not available, and the skill becomes available when the gauge value becomes greater than or equal to the necessary gauge value. The gauge values are managed on a per-skill basis, and in the state where the skills are unavailable, the skill gauges 48a, 48b, and 48c are partially or entirely grayed out, as shown in FIG. 5B. Then, as the gauge values increase and approach the necessary gauge values, the grayed-out areas decrease, as shown in FIG. 5C.

FIG. 5C shows the state in which the skill corresponding to the skill gauge 48a is available and in which the skills corresponding to the skill gauges 48b and 48c are unavailable. In the state shown in FIG. 5C, the player can use the skill corresponding to the skill gauge 48a by tapping the skill gauge 48a. When the skill is used, the gauge value corresponding to the skill becomes zero, whereby the skill becomes unavailable. In this manner, the skill gauges 48a, 48b, and 48c also function as operating parts for using skills.

Furthermore, in the battle game screen, a dragonization gauge 50 is displayed. As described earlier, each participating character can be equipped with a dragon. The dragonization gauge 50 reports a dragon that the operable character is equipped with, whether or not transformation into the dragon is permitted, and the gauge value remaining before transformation into the dragon becomes possible.

Specifically, each dragon or each participating character has set therefor in advance a gauge value necessary for enabling transformation into the dragon. The gauge value of the dragonization gauge 50 increases, for example, in accordance with the value of damage given to the boss character 42 or the like by the operable character. Transformation into the dragon is not permitted in the state where the gauge value is less than the necessary gauge value, and transformation into the dragon is enabled when the gauge value becomes greater than or equal to the necessary gauge value. The gauge value necessary for transformation into the dragon is managed separately from the skills described above, and in the state where transformation into the dragon is disabled, the dragonization gauge 50 is partially or entirely grayed out, as shown in FIG. 5B. Then, as the gauge value increases and approaches the necessary gauge value, the grayed-out areas decrease.

FIG. 5C shows the state in which the operable character can transform itself into the dragon that the operable character is equipped with. In the state shown in FIG. 5C, the player can transform the operable character into the dragon by tapping the dragonization gauge 50. For example, when the dragonization gauge 50 is tapped in the state shown in FIG. 5C, the operable character (the first participating character 40a here) transforms itself into the dragon, as shown in FIG. 5D. In this state, the dragon is displayed in the operable-character displaying part 46 and the character-information displaying part corresponding to the operable character (the first character-information displaying part 44a here), and then the player can cause the dragon to perform actions by inputting operations to the player terminal 1.

Upon the transformation into the dragon, the gauge value for the dragon becomes zero, whereby transformation into the dragon is again disabled. During the period in which the operable character is transformed into the dragon, the dragonization gauge 50 is displayed in the manner shown in FIG. 5D. The period during which transformation into the dragon is enabled (transformation enabled period) is set in advance, and after the expiration of the transformation enabled period, the dragon is transformed back to the original participating character (the first participating character 40a here), and the dragonization gauge 50 is displayed in a grayed-out manner, as shown in FIG. 5B.

Although not described in detail, gauge values for dragons and gauge values for individual skills are also managed in relation to non-operated characters. However, with non-operated characters, although there are cases where the skills are used under computer control, transformation into a dragon does not occur.

Furthermore, in an upper part of the battle game screen, a boss-character HP meter 42x indicating the HPs of the boss character 42, as well as a time limit, i.e., the time remaining before the end of the battle game, are displayed. Each battle game has a clearing condition (winning condition) and a defeat condition (failure to satisfy the clearing condition) set therefor in advance. The player wins when the winning condition is satisfied in the battle game, while the player is defeated when the defeat condition is satisfied, and the battle game comes to an end. Here, the condition that the HPs of the boss character 42 have become zero is set as the winning condition, and the player wins when the HPs of the boss character 42 have become zero.

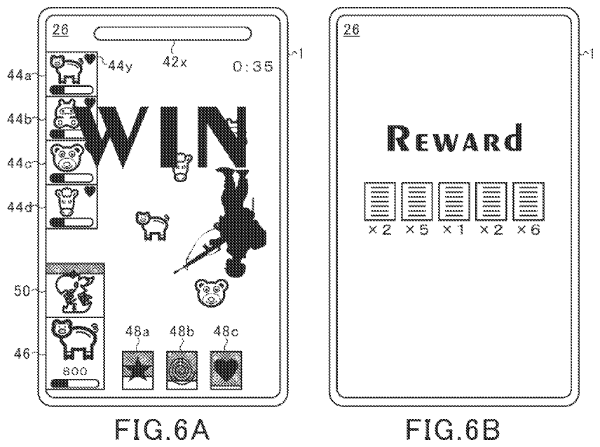

FIG. 6A is an illustration for explaining an example battle game screen for the case of a victory for the player. FIG. 6B is an illustration for explaining an example reward screen. When the HPs of the boss character 42 have become zero, an image reporting a victory for the player is displayed, as shown in FIG. 6A, and the battle game comes to an end. Then, the reward screen is displayed, as shown in FIG. 6B, reporting the reward acquired as a result of the success in the quest, i.e., the victory in the battle game. The reward that can be acquired by the player varies among the individual quests, and also varies depending on the number of continuations as well as the number of respawns.

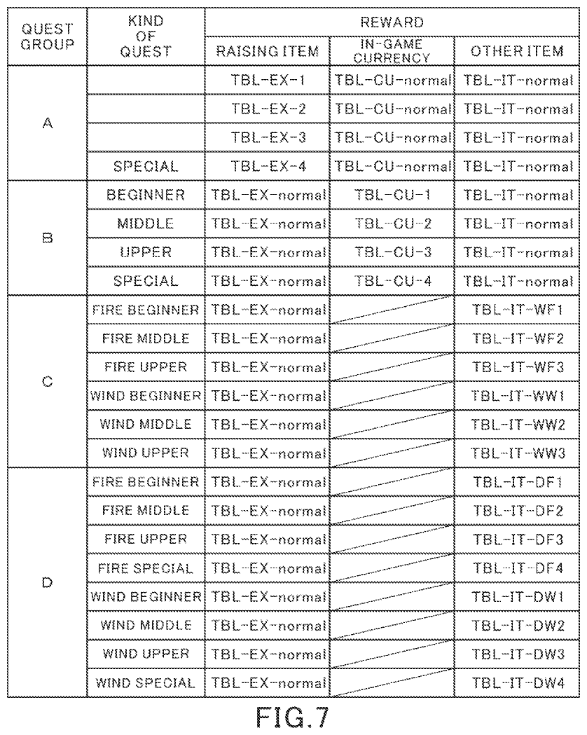

FIG. 7 is a figure for explaining example reward tables. When the player has won a battle game, i.e., when the player has cleared a quest, rewards that are given to the player are determined through lotteries using reward tables. The reward tables that are selected at this time are preset for each kind of quest. For example, as shown in FIG. 7, in the case where the quest “beginner” is cleared among the quests classified into group A, rewards are determined by using a reward table TBL-EX-1, a reward table TBL-CU-normal, and a reward table TBL-IT-normal.

Raising items are determined according to the reward table TBL-EX-1, a sum of the in-game currency is determined according to the reward table TBL-CU-normal, and items other than raising items, such as character enhancing items or dragon-related items, are determined according to the reward table TBL-IT-normal. That is, upon clearing the quest “beginner” classified into group A, the player can acquire raising items, a sum of the in-game currency, or other items as rewards.

Note that here, as an example, with the quests classified into group A, the reward tables for raising items vary depending on the difficulty levels. The reward tables for raising items, which are used when quests classified into group A are cleared, are set such that the number of raising items as rewards increases as the difficulty level becomes higher.

Furthermore, as shown in FIG. 7, here, also in the case where a quest classified into group B, group C, or group D is cleared, the number of raising items that are given as rewards is determined by using a reward table for raising items (TBL-EX-normal here). Note, however, that the reward table for raising items, which is used in the case where a quest classified into group B, group C, or group D is cleared, is set such that the number of raising items that are given as rewards is less compared with the reward tables for raising items, which are used when quests classified into group A are cleared. Thus, the player can acquire a greater number of raising items in the case where a quest classified into group A is cleared than in the case where a quest classified into another group is cleared.

As another example, in the case where the quest “beginner” is cleared among the quests classified into group B, rewards are determined by using a reward table TBL-EX-normal, a reward table TBL-CU-1, and the reward table TBL-IT-normal.

A sum of the in-game currency is determined according to the reward table TBL-CU-1. Thus, upon clearing the quest “beginner” classified into group B, the player can acquire raising items, a sum of the in-game currency, and other items as rewards.

Note that here, as an example, with the quests classified into group B, the reward tables for the in-game currency raising vary depending on the difficulty levels. The reward tables for the in-game currency, which are used when quests classified into group B are cleared, are set such that the sum of the in-game currency increases as the difficulty level becomes higher.

Furthermore, as described above, here, also in the case where a quest classified into group A is cleared, a sum of the in-game currency that is given as a reward is determined by using the reward table for the in-game currency (TBL-CU-normal here). Note, however, that the reward table for the in-game currency, which is used in the case where a quest classified into group A is cleared, is set such that the sum of the in-game currency that is given as a reward is less compared with the reward tables for the in-game currency, which are used when quests classified into group B are cleared. Thus, the player can acquire a greater sum of the in-game currency items in the case where a quest classified into group B is cleared than in the case where a quest classified into another group is cleared.

As another example, in the case where a quest classified into group C or group D is cleared, rewards are determined by using a reward table for raising items and a reward table for other items. Therefore, in the case where a quest classified into group C or group D is cleared, raising items and other items are determined as rewards.

Note that the other items include character enhancing items and dragon-related items, described earlier. According to the reward tables for other items, which are used in the case where quests classified into group C are cleared, character enhancing items are always determined. Each of the reward tables is set such that character enhancing items having an attribute matching the attribute of the quest are determined at this time. Furthermore, each of the reward tables is set that the number of character enhancing items increases as the difficulty level becomes higher among quests having the same attribute and different difficulty levels.

Furthermore, according to the reward tables for other items, which are used in the case where quests classified into group D are cleared, dragon-related items are always determined. Each of the reward tables is set such that dragon-related items having an attribute matching the attribute of the quest are determined at this time. Furthermore, each of the reward tables is set that the number of dragon-related items increases as the difficulty level becomes higher among quests having the same attribute and different difficulty levels.

As described above, each quest has reward tables associated therewith in advance. Furthermore, when a quest is cleared, rewards that are given to the player are determined by using reward tables associated with the cleared quest. This makes it possible to vary rewards that are given to the player among the kinds of quests. Note that although it is assumed here that rewards are determined through lotteries for all quests, fixed rewards may be set for some or all of the quests.

Furthermore, it is assumed here that shared reward tables are used for both normal plays and skip plays. Therefore, there are no differences between rewards that are given to the player between normal plays and skip plays. Alternatively, however, some or all of the reward tables may be varied between normal plays and skip plays. For example, reward tables may be set such that normal plays are more advantageous for the player than skip plays.

(Daily Missions and Additional Rewards)

Here, in this embodiment, there are cases where additional rewards are given to the player separately from normal rewards that are given when a quest is cleared. Specifically, in this embodiment, daily missions are set for each prescribed period. Here, one day is set as the prescribed period. Therefore, the daily missions are updated every day. The daily missions include clearing some quests, more strictly, quests classified into some groups. When a quest classified into one of the groups designated as constituting daily missions are cleared, additional rewards are given to the player a number of times within a preset upper limit for one day.

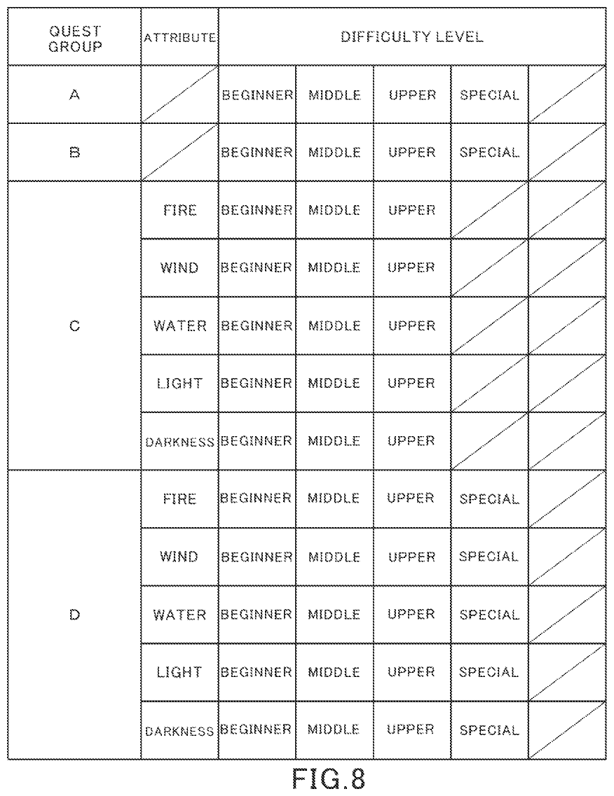

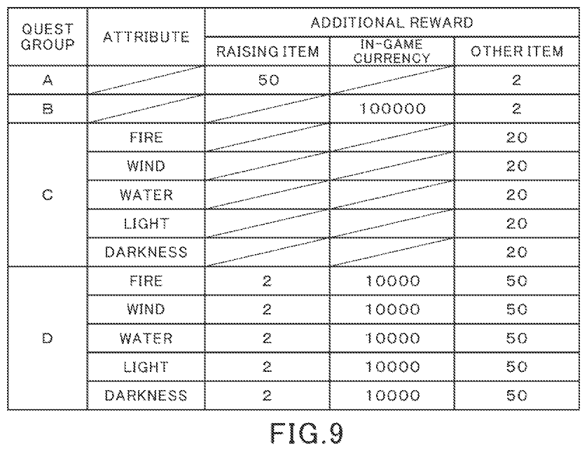

FIG. 8 is a figure for explaining an example of quests constituting daily missions. Furthermore, FIG. 9 is a figure for explaining an example of additional rewards. FIG. 8 shows quests designated as constituting daily missions. As described above, daily missions are designated on a per-group basis. Here, group A, group B, group C, and group D are designated as constituting daily missions. Furthermore, here, the upper limit for the number of times that additional rewards can be acquired is set to once a day per group, and the content of the additional rewards varies among the individual groups.

For example, the additional rewards for group A are given to the player when one of the quests classified into group A is cleared for the first time during one day. Here, as shown in FIG. 9, the same additional rewards are given irrespective of the difficulty level of the quest classified into group A. Alternatively, however, the number and content of the additional rewards may vary depending on the difficulty level of the quest classified into group A. Here, fifty raising items and two other items are given to the player as the additional rewards for group A.

Furthermore, the additional rewards for group B are given to the player when one of the quests classified into group B is cleared for the first time during one day. At this time, the same additional rewards are given irrespective of the difficulty level of the quest classified into group B. Alternatively, however, the number and content of the additional rewards may vary depending on the difficulty level of the quest classified into group B. Here, a sum of 100,000 of the in-game currency and two other items are given to the player as the additional rewards for group B.

Furthermore, the additional rewards for group C are given to the player when one of the quests classified into group C is cleared for the first time during one day. As described above, for group A and group B, the same additional rewards are given irrespective of the kind of quest classified into one of these groups, i.e., the difficulty level thereof; meanwhile, for group C, different additional rewards are given depending on the kinds of quests.

Specifically, in the case where a quest classified into group C is cleared, the content of the additional rewards varies depending on the attribute of the quest cleared. For example, in the case where a quest having the attribute “fire” is cleared, twenty character enhancing items having the attribute “fire” are given as the additional rewards, and in the case where a quest having the attribute “light” is cleared, twenty character enhancing items having the attribute “light” are given as the additional rewards.

As described above, the additional rewards for a quest classified into group C match the attribute of the quest cleared. Note, however, that the additional rewards for quests classified into group C are the same for each attribute irrespective of the difficulty levels of the quests. Therefore, for example, the additional rewards that are given are the same between the case where the quest “beginner” of the attribute “fire” is cleared and the case where the quest “upper” of the same attribute is cleared. Alternatively, however, the number and content of the additional rewards may vary depending on the difficulty level of the quest classified into group C.

Furthermore, the additional rewards for group D are given to the player when one of the quests classified into group D is cleared for the first time during one day. Note that also for group D, similarly to group C, different additional rewards are given depending on the kinds of quests.

Specifically, in the case where a quest classified into group D is cleared, raising items, a sum of the in-game currency, and dragon-related items are given as the additional rewards. At this time, the raising items and the sum of the in-game currency are the same irrespective of the attribute and the difficulty level of the quest cleared. Meanwhile, the content of the dragon-related items varies depending on the attribute of the quest cleared. For example, in the case where a quest having the attribute “wind” is cleared, fifty dragon-related items having the attribute “wind” are given, and in the case where a quest having the attribute “darkness” is cleared, fifty character enhancing items having the attribute “darkness” are given.

As described above, some of the additional rewards for the quests classified into group D match the attribute of the quests cleared, while the others are the same irrespective of the attributes of the quests. Note that the number and content of the additional rewards may vary depending on the difficulty level of the quest classified into group D. Furthermore, in the case where a quest classified into group D is cleared, dragon-related items not having attributes may be included in the additional rewards. In this case, it is desired that the dragon-related items not having attributes are the same irrespective of the attribute of the quest cleared.

As described above, in this embodiment, for each of a plurality of quests for which the player can satisfy the clearing condition, it is possible to acquire additional rewards within an upper-limit number of times per prescribed period. Furthermore, in the case where a quest through which it is possible to acquire additional rewards is accomplished, additional rewards are given to the player on condition that the number of times of the acquisition of additional rewards during one prescribed period is less than the upper-limit number of times. Therefore, the player can acquire four kinds of additional rewards every day by clearing individual quests classified into groups A, B, C, and D once a day.

Note that it is assumed here that the content of the additional rewards is set in advance and that the additional rewards having the same content are given to the player every day. Alternatively, however, the content of the additional rewards may be determined through lotteries, similarly to normal rewards.

Furthermore, it is assumed here that additional rewards are given to the player when a quest designated as constituting a daily mission is cleared for the first time during one day. Alternatively, however, the configuration may be such that the player is allowed to choose whether or not to receive additional rewards upon clearing a quest designated as constituting a daily mission. In this case, for example, if the player chooses not to receive additional rewards, the additional rewards remains not yet acquired. In the case where the player rejects receiving additional rewards, as described above, the player should be allowed to again choose whether or not to receive the additional rewards when a quest corresponding to the group for which the additional rewards are set is cleared the next time.

Here, in this embodiment, whether or not additional rewards have been acquired is reported to the player, as shown in FIG. 4A. As described earlier, the group-selection operating parts 31 are displayed in the group selection screen. At this time, additional reward information 36 looking like a treasure box is displayed in each of the group-selection operating parts 31 corresponding to the groups designated for daily missions. The additional reward information 36 is displayed in either of two kinds of display modes, namely, a not-yet-acquired display mode and an acquired display mode.

In each of the group-selection operating parts 31 for the groups of quests with which additional rewards have not been acquired, the additional reward information 36 is displayed in the not-yet-acquired display mode. As indicated in the group-selection operating parts 31 for group A and group B in FIG. 4A, an image of a closed treasure box is displayed in the not-yet-acquired display mode of the additional reward information 36. Meanwhile, as indicated in the group-selection operating part 31 for group C in FIG. 4A, an image of an opened treasure box is displayed in the acquired display mode of the additional reward information 36. As such, the groups of quests with which additional rewards can be acquired are reported in the form of the additional reward information 36 in the group selection screen.

Note that there are cases where a campaign period in which additional rewards or normal rewards are doubled for some quests or some groups is set. When one of the subject quests is cleared during this campaign period, twice as many rewards as in the normal period are given to the player. Campaign subject information (the label “Dobie” here) is displayed in each of the group-selection operating parts 31 including the subject groups of the campaign period or the subject quests of the campaign period.

Here, in this embodiment, four kinds of quest groups are designated as constituting daily missions in this embodiment. The quests designated as constituting daily missions are the same every day. Therefore, in order to acquire all the additional rewards every day, it is necessary to clear each of the quests classified into group A, group B, group C, and group D at least once a day. In this case, the player might feel a sense of duty that the player has to clear the same quests every day.

In particular, when a plurality of quests are designated as constituting daily missions, the player has to repeatedly play quests a plurality of times, which requires laborious operations. Furthermore, the player has to distinguish whether or not additional rewards have been acquired via the additional reward information 36 displayed in the group-selection operating parts 31. Thus, the operation for checking whether or not additional rewards can be acquired might in itself becomes laborious.

(Batch Skipping Function)

Thus, in this embodiment, a batch skipping function is provided in order to improve the ease of operation for the player, thereby enhancing the motivation for playing. The batch skipping function makes it possible to play quests designated as constituting daily missions as a batch. Here, the batch skipping function makes it possible to execute, as a batch, skip plays of quests designated as constituting daily missions. As shown in FIG. 4A, a batch skipping icon 37 is displayed in the group selection screen. The player can use the batch skipping function by tapping the batch skipping icon 37.

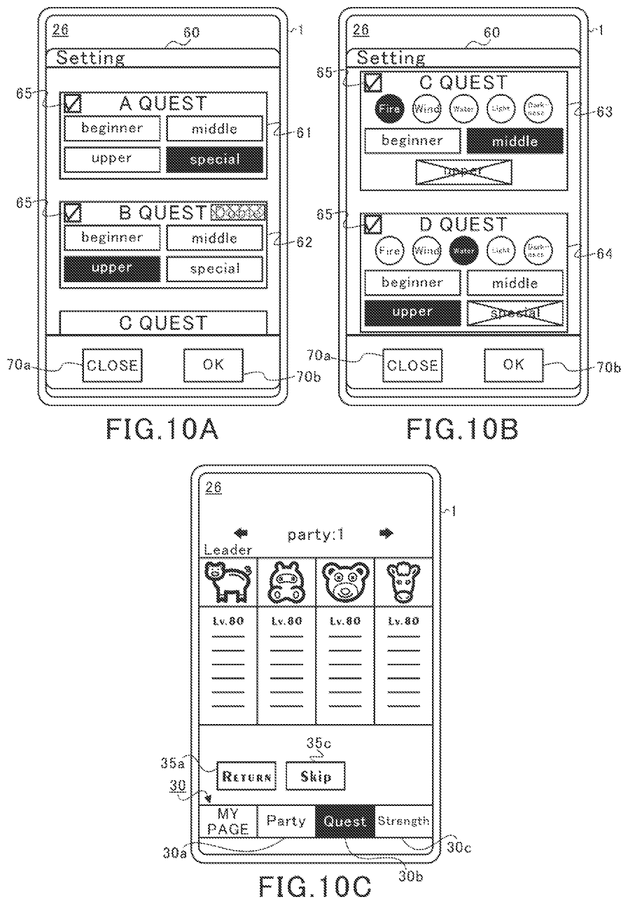

FIG. 10A is a first illustration for explaining an example batch-skipping-function setting dialog 60. FIG. 10B is a second illustration for explaining an example batch-skipping-function setting dialog 60. FIG. 10C is an illustration for explaining an example party selection screen at the time of batch skipping. The following describes the case where additional rewards have not yet been acquired for all of the four groups from group A to group D. When the batch skipping icon 37 is tapped, the batch-skipping-function setting dialog 60 is displayed on the display 26. In the batch-skipping-function setting dialog 60, designated-quest setting operating parts are displayed.

The designated-quest setting operating parts are provided for the individual groups of quests designated as constituting daily missions. Therefore, here, as the designated-quest setting operating parts, a group-A designated-quest setting operating part 61, a group-B designated-quest setting operating part 62, a group-C designated-quest setting operating part 63, and a group-D designated-quest setting operating part 64 are displayed in the batch-skipping-function setting dialog 60.

Note that in the batch-skipping-function setting dialog 60, the group-A designated-quest setting operating part 61, the group-B designated-quest setting operating part 62, the group-C designated-quest setting operating part 63, and the group-D designated-quest setting operating part 64 are displayed in this order from the top. In the batch-skipping-function setting dialog 60, when a flick operation in the vertical direction is input, the designated-quest setting operating parts are scrolled.

In the group-A designated-quest setting operating part 61, four difficulty-level designating tabs indicating “beginner”, “middle”, “upper”, and “special” are provided. The player can select a quest classified into group A, i.e., the difficulty level thereof, by tapping one of the four difficulty-level designating tabs. When one of the difficulty-level designating tabs is tapped, the quest having the difficulty level corresponding to the tapped difficulty-level designating tabs becomes tentatively selected at the player terminal 1. FIG. 10A shows a state in which the quest “special” classified into group A is tentatively selected. Here, the tentatively selected difficulty-level designating tab is displayed in a highlighted manner so that the tentatively selected quest can be distinguished.

Furthermore, In the group-B designated-quest setting operating part 62, similarly to the group-A designated-quest setting operating part 61 described above, four difficulty-level designating tabs indicating “beginner”, “middle”, “upper”, and “special” are provided. FIG. 10A shows a state in which the quest “special” classified into group B is tentatively selected. Furthermore, for groups including quests that are subject to a campaign period, campaign subject information (the label “Dobie” here) is displayed also in the designated-quest setting operating parts.

Furthermore, as shown in FIG. 10B, in the group-C designated-quest setting operating part 63, five attribute designating tabs indicating the individual attributes “fire”, “wind”, “water”, “light”, and “darkness”, as well as three difficulty-level designating tabs indicating “beginner”, “middle”, and “upper”, are provided. FIG. 10B shows a state in which the quest “middle” having the attribute “fire”, classified into group C, is tentatively selected.

In the group-D designated-quest setting operating part 64, five attribute designating tabs indicating the individual attributes “fire”, “wind”, “water”, “light”, and “darkness”, as well as four difficulty-level designating tabs indicating “beginner”, “middle”, “upper”, and “special”, are provided. FIG. 10B shows a state in which the quest “upper” having the attribute “water”, classified into group D, is tentatively selected.

Here, in the batch-skipping-function setting dialog 60, for quests that do not satisfy the skipping conditions, difficulty-level designating tabs are displayed so that the tabs cannot be selected by the player. For example, suppose that the skipping condition is not satisfied with the quest “upper” having the attribute “fire” among the quests classified into group C. In this case, in the group-C designated-quest setting operating part 63, when the attribute designating tab for “fire” is tapped, the operation of the difficulty-level designating tab for “upper” becomes disabled, and only the difficulty-level designating tabs for “beginner” and “middle” are displayed operably.

Furthermore, for example, suppose that the skipping condition is not satisfied with the quest “special” having the attribute “water” among the quests classified into group D. In this case, in the group-D designated-quest setting operating part 64, when the attribute designating tab for “water” is tapped, the operation of the difficulty-level designating tab for “special” becomes disabled, and only the difficulty-level designating tabs for “beginner”, “middle”, and “upper” are displayed operably.

Note that there are also quests having releasing conditions set therefor, separately from the skipping conditions. A releasing condition is a condition with which it becomes possible for the player to play the corresponding quest. For example, suppose that the quest “special” in group D has set therefor a releasing condition that all the quests belonging to chapter 2 of the main story have been cleared. In this case, a player who has not cleared all the quests belonging to chapter 2 of the main story is not allowed to play the quest “special” in group D.

As such, for quests for which releasing conditions are not satisfied, similarly to the case where skipping conditions are not satisfied, the designated-quest setting operating parts are not displayed, or are displayed non-operably.

Furthermore, in the batch-skipping-function setting dialog 60, only the designated-quest setting operating parts corresponding to the groups with which additional rewards have not yet been acquired are displayed. Therefore, for example, in the case where additional reward for the current day have already been acquired with a quest classified into group A, in the batch-skipping-function setting dialog 60, the group-A designated-quest setting operating part 61 is not displayed, and only the group-B designated-quest setting operating part 62, the group-C designated-quest setting operating part 63, and the group-D designated-quest setting operating part 64 are displayed.

That is, in the batch-skipping-function setting dialog 60, the player is allowed to perform setting operations only for the groups of quests with which additional rewards for the current day can be acquired at the current timing. Furthermore, the player can select quests for which the batch skipping function is to be used from among the quests with which additional rewards can be acquired. Specifically, a checkbox 65 is provided in each of the designated-quest setting operating parts, and the player can switch between a selected state and a non-selected state by tapping the checkbox 65. A checkmark is placed in the checkbox 65 in the selected state, and a checkmark is not placed in the checkbox 65 in the non-selected state.

Furthermore, on the display 26, a close button 70a and an OK button 70b are provided under the batch-skipping-function setting dialog 60. When the OK button 70b is tapped, the tentatively selected quest is registered. The quest registered at this time is saved at the player terminal 1, and when the batch-skipping-function setting dialog 60 is displayed again, attribute designating tabs and difficulty-level designating tabs are displayed in a highlighted manner on the basis of the saved information. When the batch-skipping-function setting dialog 60 is displayed, the quest currently selected by the player is displayed in a highlighted manner.

Furthermore, when the close button 70a is tapped, the batch-skipping-function setting dialog 60 is closed, and the group selection screen is displayed on the display 26. In this case, even if the tentatively selected quest has been changed after the start of displaying of the batch-skipping-function setting dialog 60, information after the change is discarded.

As described above, in the batch-skipping-function setting dialog 60, the player can select the kinds of quests to be skip-played from among the quests designated as constituting daily missions. Furthermore, since the kinds of quests selected by the player are saved at the player terminal 1, a laborious operation such as reselecting the same quests each time becomes unnecessary.

Furthermore, when the OK button 70b is tapped, the party selection screen is displayed, as shown in FIG. 10C. In the party selection screen, the player can select and form a party to be used with the batch skipping function. Note that in the party selection screen, the party that was used in the previous use of the batch skipping function is initially displayed. The party selected in the party selection screen is used in all the quests that are subjected to the batch skipping function. Alternatively, however, it may be allowed to set a party to use on a per-quest basis in the party selection screen.

Furthermore, in the case where the player has selected a quest to play from the group-selection operating parts in the group selection screen shown in FIG. 4A, a start button 35b is displayed in the party selection screen, as shown in FIG. 4D. Meanwhile, in the case where the batch skipping icon 37 is tapped and the party selection screen is displayed via the batch-skipping-function setting dialog 60, the start button 35b is not displayed, and only a return button 35a and a skip button 35c are displayed, as shown in FIG. 10C. That is, when the batch skipping function is used, the player is not allowed to select a normal play, and is allowed to select only a skip play.

Note that when the return button 35a is tapped, the batch-skipping-function setting dialog 60 is displayed on the display 26. Furthermore, when the skip button 35c is tapped, a ticket setting screen is displayed.

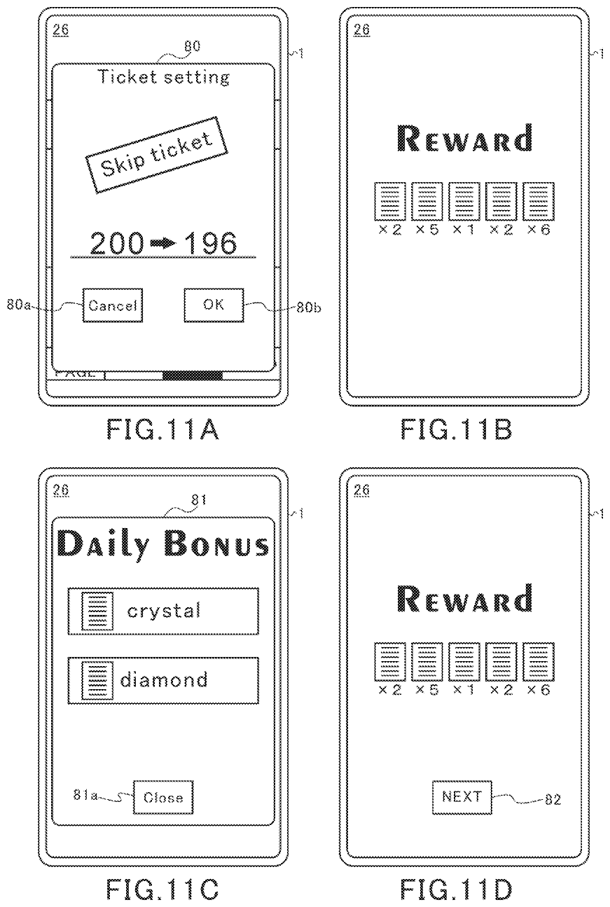

FIG. 11A is an illustration for explaining an example ticket setting screen. FIG. 11B is an illustration for explaining an example first aggregated reward screen. FIG. 11C is an illustration for explaining an example additional reward screen. FIG. 11D is an illustration for explaining an example second aggregated reward screen. As shown in FIG. 11A, a ticket-use confirmation dialog 80 is displayed in the ticket setting screen. In the ticket-use confirmation dialog 80, the number of skipping tickets currently possessed by the player, as well as the number of skipping tickets that will remain after the batch skipping function is used, are displayed.

Here, since a skip play is performed as a batch for four kinds of quests, it is indicated that four skipping tickets will be consumed. Furthermore, in the ticket-use confirmation dialog 80, a cancel button 80a and a batch-skipping start button 80b are provided. When the cancel button 80a is tapped, the party selection screen shown in FIG. 10C is displayed. Meanwhile, when the batch-skipping start button 80b is tapped, a batch skipping process is executed.

In the case where the player does not possess a necessary number of skipping tickets, the batch-skipping start button 80b is set to be non-operable. That is, here, the batch-skipping start button 80b becomes enabled in the case where the player possesses a number of skipping tickets not less than the number of quests that are subjected to the batch skipping process.

Alternatively, however, the configuration may be such that the skip process is executed only for some quests even in the case where the number of skipping tickets possessed by the player is less than the number of quests that are subjected to the batch skipping process. For example, suppose that the number of quests that are subjected to the batch skipping process is four, and the number of skipping tickets possessed by the player is two. The configuration may be such that, in this case, when the batch-skipping start button 80b is tapped, the skipping process is executed only for prescribed two quests, and the skipping process is not executed for the other two quests.

When the batch skipping process is executed, for each of the subject quests selected by the player, normal rewards are determined by using reward tables, as described earlier. Furthermore, for each of the subject quests selected by the player, additional rewards shown in FIG. 9 are determined.

When the batch skipping process is executed, a first aggregated reward screen is displayed, as shown in FIG. 11B. In the first aggregated reward screen, all the rewards determined by using reward tables are shown in an aggregated manner. Alternatively, however, rewards determined may be displayed separately for individual quests in the first aggregated reward screen.

Furthermore, after the elapse of a prescribed time since the first aggregated reward screen is displayed, an additional reward screen shown in FIG. 11C is displayed. In the additional reward screen, an additional reward tab 81 is displayed. In the additional reward tab 81, a list of acquired additional rewards is displayed. As such, acquired additional rewards are displayed in the additional reward tab 81 separately from normal rewards, which makes it easy for the player to recognize the accomplishment of daily missions.

A close button 81a is provided in the additional reward tab 81, and the additional reward tab 81 becomes hidden when the close button 81a is tapped. When the additional reward tab 81 becomes hidden, a second aggregated reward screen shown in FIG. 11D is displayed. In the second aggregated reward screen, similarly to the first aggregated reward screen, normal rewards are displayed, and a next button 82 is newly displayed. When the next button 82 is tapped, the series of processing steps concerning the batch skipping process comes to an end, and for example, the group selection screen shown in FIG. 4A is displayed on the display 26. At this time, the display mode of the additional reward information 36 is changed from the not-yet-acquired display mode to the acquired display mode.

The following describes in detail the functional configuration of the information processing system S, as well as functional units and processes mainly concerning the batch skipping function among processes that are carried out by the individual functional units.

(Functional Configuration of Information Processing System S)

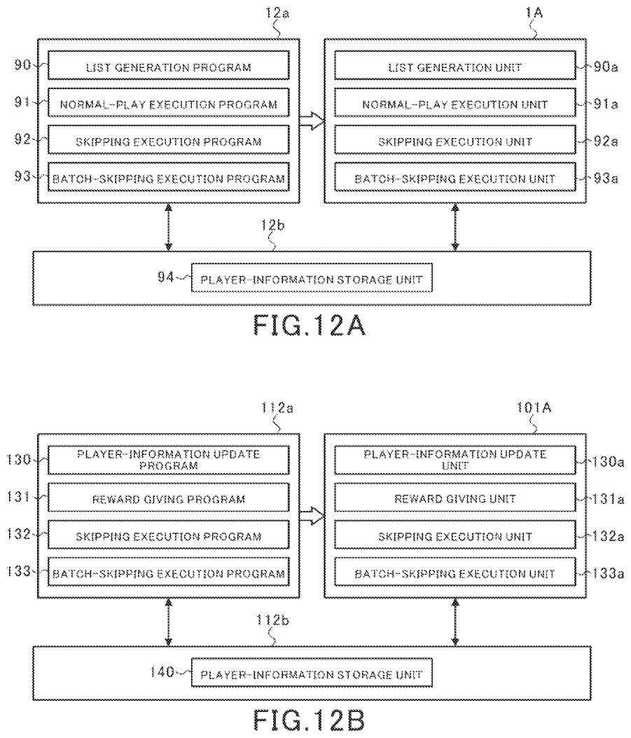

FIG. 12A is a diagram for explaining the configuration of the memory 12 in the player terminal 1, as well as the functions thereof as a computer. FIG. 12B is a diagram for explaining the configuration of the memory 112 in the server 100, as well as the functions thereof as a computer.

In the memory 12 of the player terminal 1, a program storage area 12a and a data storage area 12b are provided. At the start of a game, the CPU 10 stores various kinds of programs (modules) in the program storage area 12a. Similarly, in the memory 112 of the server 100, a program storage area 112a and a data storage area 112b are provided. At the start of a game, the CPU 110 stores various kinds of programs (modules) in the program storage area 112a.

The programs that are stored in the program storage area 12a of the player terminal 1 include a list generation program 90, a normal-play execution program 91, a skipping execution program 92, and a batch-skipping execution program 93. Note that the programs listed in FIG. 12A are examples, and the programs that are stored in the program storage area 12a include a large number of other programs.

Furthermore, in the data storage area 12b of the player terminal 1, a player-information storage unit 94 is provided as a storage unit that stores data. Note that the storage unit listed above is an example, and a large number of other storage units are provided in the data storage area 12b.

The CPU 10 runs the individual programs stored in the program storage area 12a, thereby updating the data in the individual storage units of the data storage area 12b. Furthermore, the CPU 10 runs the individual programs stored in the program storage area 12a, thereby causing the player terminal 1 to function as a game control unit 1A.

The game control unit 1A includes a list generation unit 90a, a normal-play execution unit 91a, a skipping execution unit 92a, and a batch-skipping execution unit 93a.

Specifically, the CPU 10 runs the list generation program 90, thereby causing the computer to function as the list generation unit 90a. Similarly, the CPU 10 runs the normal-play execution program 91, the skipping execution program 92, and the batch-skipping execution program 93, thereby causing the computer to function as the normal-play execution unit 91a, the skipping execution unit 92a, and the batch-skipping execution unit 93a, respectively.

The list generation unit 90a generates a list by extracting the groups of quests with which additional rewards for the current day can be acquired. The batch-skipping-function setting dialog 60 is displayed on the basis of the list generated by the list generation unit 90a.

The normal-play execution unit 91a controls the execution of a quest via solo-play. Specifically, the normal-play execution unit 91a controls movements and actions of participating characters on the basis of operations input by the player, and controls movements and actions of enemy characters through computational processing by the computer. Furthermore, the normal-play execution unit 91a carries out all the processing necessary for the execution of a quest via solo-play, such as computing damage values on the basis of various parameters.

The skipping execution unit 92a issues an instruction to the server 100 so that a skipping process will be executed for a quest selected by the player.

The batch-skipping execution unit 93a issues an instruction to the server 100 so that a batch skipping process will be executed for quests selected in the batch-skipping-function setting dialog 60.

Furthermore, the programs that are stored in the program storage area 112a of the server 100 include a player-information update program 130, a reward giving program 131, a skipping execution program 132, and a batch-skipping execution program 133. Note that the programs listed in FIG. 12B are examples, and the programs that are stored in the program storage area 112a include a large number of other programs.

Furthermore, in the data storage area 112b of the server 100, a player-information storage unit 140 is provided as a storage unit that stores data. Note that the storage unit listed above is an example, and a large number of other storage units are provided in the data storage area 112b.

The CPU 110 runs the individual programs stored in the program storage area 112a, thereby updating the data in the individual storage units of the data storage area 112b. Furthermore, the CPU 110 runs the individual programs stored in the program storage area 112a, thereby causing the server 100 to function as a game control unit 101A.

The game control unit 101A includes a player-information update unit 130a, a reward giving unit 131a, a skipping execution unit 132a, and a batch-skipping execution unit 133a.

Specifically, the CPU 110 runs the player-information update program 130, thereby causing the computer to function as the player-information update unit 130a. Similarly, the CPU 110 runs the reward giving program 131, the skipping execution program 132, and the batch-skipping execution program 133, thereby causing the computer to function as the reward giving unit 131a, the skipping execution unit 132a, and the batch-skipping execution unit 133a, respectively.

The player-information update unit 130a updates the player information in the player-information storage unit 140.

The reward giving unit 131a determines normal rewards and additional rewards to be given to the player. Furthermore, the reward giving unit 131a updates the determined number of rewards in the player-information storage unit 140.

The skipping execution unit 132a executes a skipping process for a quest selected by the player.

The batch-skipping execution unit 133a executes a batch skipping process for quests selected in the batch-skipping-function setting dialog 60.

Next, an example of processes that are executed by the information processing system S will be described. In the following, processes that are carried out at the player terminal 1 will be signified as Pn (n is an arbitrary integer), and processes that are carried out at the server 100 will be signified as Sn (n is an arbitrary integer).

(Processes by Information Processing System S)

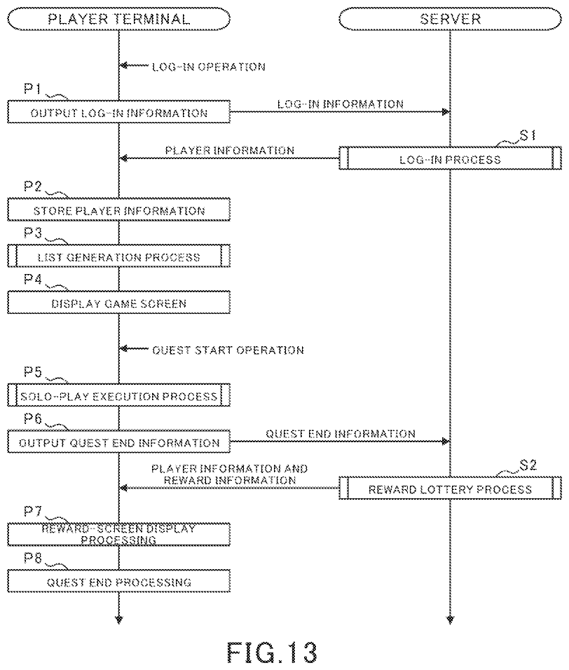

FIG. 13 is a sequence chart for explaining basic processes at the player terminal 1 and the server 100. When a log-in operation is input to the player terminal 1, log-in information is transmitted to the server 100 (P1). Upon receiving the log-in information, the server 100 executes a log-in process (S1).

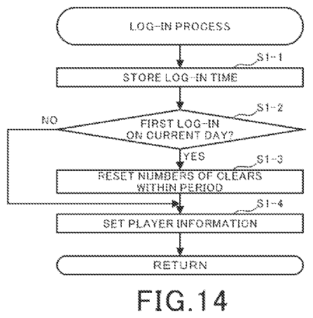

FIG. 14 is a flowchart for explaining the log-in process at the server 100. At the server 100, the player-information update unit 130a stores the time of receipt of the log-in information in the player-information storage unit 140 as the log-in time (S1-1). Furthermore, the player-information update unit 130a checks the log-in time stored in the player-information storage unit 140 to determine whether or not the log-in is the first log-in on the current day (S1-2). If the log-in is the first log-in on the current day (YES in S1-2), the numbers of clears within the period are reset (S1-3).

Note that the numbers of clears within the period are stored for the individual groups of quests designated as constituting daily missions. That is, in the player-information storage unit 140, areas for storing the individual numbers of clears within the period for group A, group B, group C, and group D are provided. The numbers of clears within the period are the numbers of times quests classified into the above four groups are cleared during one day.

Therefore, here, the number of clears within the period is reset on the occasion of the first log-in during one day. By clearing the numbers of clears within the period, for each of the plurality of quests that the player can clear, it becomes possible for the player to acquire additional rewards within the upper-limit number of times per prescribed period. That is, the processing in S1-3 is processing that makes it possible to acquire a privilege, within the upper-limit number of times per prescribed period, for each of a plurality of missions that the player can accomplish.

Furthermore, the player-information update unit 130a sets the various kinds of player information stored in the player-information storage unit 140 so that the player information can be received by the player terminal 1 (S1-4). Note that the player information that is set here includes the number of clears within the period.

Referring back to FIG. 13, at the player terminal 1, upon receiving the player information set at the server 100, the received player information is stored in the player-information storage unit 94 (P2). Then, the list generation unit 90a of the player terminal 1 generates a list on the basis of the received numbers of clears within the period (P3).

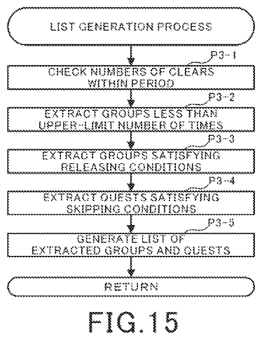

FIG. 15 is a flowchart for explaining a list generation process at the player terminal 1. The list generation unit 90a checks the numbers of clears within the period, stored in the player-information storage unit 94 (P3-1). Then, the list generation unit 90a extracts groups with which the numbers of clears within the period are less than the upper-limit number of times (once here) from among the groups of quests designated as constituting daily missions (P3-2). Furthermore, the list generation unit 90a extracts groups that satisfy releasing conditions from among the groups extracted in P3-2 (P3-3). The list generation unit 90a extracts quests that satisfy skipping conditions from among the quests classified into the groups extracted in P3-3 (P3-4). Furthermore, the list generation unit 90a generates a list of the groups and quests extracted in P3-4, and saves the list in the player-information storage unit 94 (P3-5). As described above, the process in P3 is a process of generating a list by extracting missions with which the numbers of the acquisition of privileges within the prescribed period are less than the upper-limit number of times.

Note that although groups that satisfy releasing conditions are extracted in P-3, this processing is not necessary. This is because groups that satisfy skipping conditions are extracted in P3-4.

Referring back to FIG. 13, at the player terminal 1, the game control unit 1A displays a game screen on the basis of the player information stored in the player-information storage unit 94 (P4). Furthermore, for example, when the quest-selection operating part 30b is tapped, the group selection screen shown in FIG. 4A is displayed. At this time, the game control unit 1A displays the additional reward information 36 in the group-selection operating parts 31 on the basis of the list generated in P3. That is, the processing in P4 is processing that makes it possible for the player to select one of a plurality of quests each classified into one of a plurality of groups and having a clearing condition set therefor.

Furthermore, for example, when the batch skipping icon 37 is tapped in the group selection screen, the game control unit 1A displays the batch-skipping-function setting dialog 60 on the basis of the list generated in P3. At this time, the game control unit 1A displays the attribute designating tabs, the difficulty-level designating tabs, and the checkboxes 65 of the designated-quest setting operating parts on the basis of the information saved in the player-information storage unit 94. That is, the processing in P4 is processing for displaying the quests extracted in the list on a per-group basis.

Furthermore, after a quest is selected in the group selection screen, when solo-play is selected as the play mode in the play-mode selection screen (see FIG. 4C), and a quest start operation (tapping of the start button 35b) is input in the party selection screen (see FIG. 4D), a solo-play execution process (P5) is started at the player terminal 1.

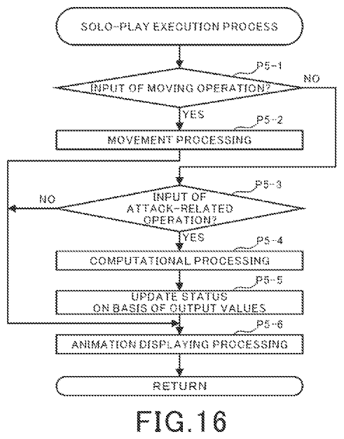

FIG. 16 is a flowchart for explaining the solo-play execution process at the player terminal 1. Note that the description here will be directed to a process for the operable character, which is operated by the player, while omitting descriptions of processes relating to other participating characters and enemy characters.

When a moving operation is input (YES in P5-1), the normal-play execution unit 91a performs movement processing for updating the position information of the operable character (P5-2). Furthermore, when an attack-related operation is input, such as a normal attack, the invocation of a skill, or dragonization, (YES in P5-3), the normal-play execution unit 91a performs computational processing (P5-4). In the computational processing, various output values, such as damage values, gauge values, values of damage received, and values of HP recovery, are calculated.

The normal-play execution unit 91a updates the statuses of participating characters and enemy characters on the basis of the calculated output values (P5-5). Furthermore, the normal-play execution unit 91a executes animation displaying processing for causing characters to perform actions (P5-6). Note that actions of non-operated characters and enemy characters are performed according to a preset program. As described above, the solo-play execution process (P5) is a process in which a quest selected by the player is executed on the basis of information set by the player or an operation input by the player.

Referring back to FIG. 13, when the quest via solo-play comes to an end, quest end information is transmitted from the player terminal 1 (P6). Upon receiving quest end information indicating the satisfaction of the clearing condition, the server 100 performs a reward lottery process (S2).

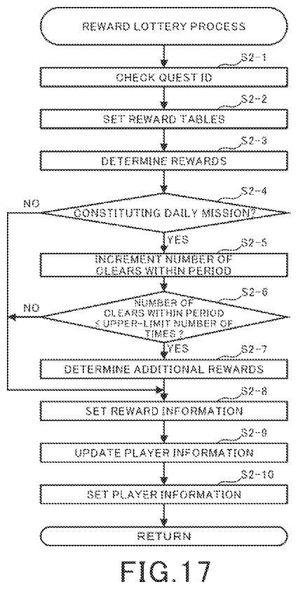

FIG. 17 is a flowchart for explaining the reward lottery process at the server 100. On the basis of the quest end information, the reward giving unit 131a of the server 100 checks the kind of quest, i.e., the quest ID, of the quest cleared by the player (S2-1). The reward giving unit 131a sets reward tables corresponding to the kind of quest (S2-2), and determines rewards to be given to the player (S2-3). Here, normal rewards, which are given to the player as a result of clearing a quest, are determined.

Furthermore, if the group into which the quest cleared is classified constitutes a daily mission (YES in S2-4), the player-information update unit 130a increments the numbers of clears within the period of the group (S2-5). Furthermore, if the number of clears within the period, updated in S2-5, is less than or equal to the upper-limit number of times (YES in S2-6), the reward giving unit 131a determines additional rewards (S2-7). Here, the additional rewards are determined on the basis of the quest cleared, or the group into which the quest cleared is classified. That is, the processing in S2-6 and S2-7 is processing for giving a privilege to the player in the case where a mission through which it is possible to acquire the privilege is accomplished, on condition that the number of times of the acquisition of the privilege within one duration of the prescribed period is less than the upper-limit number of times.

The reward giving unit 131a sets reward information so that the reward information can be received by the player terminal 1, the reward information indicating the kinds and numbers of rewards determined in S2-3 and S2-7 (S2-8). Furthermore, the player-information update unit 130a updates the determined numbers of rewards, etc. in the player-information storage unit 140 on the basis of the rewards determined in S2-3 and 2-7 (S2-9). Thus, rewards are given to the player. Furthermore, the player-information update unit 130a sets prescribed player information so that the player information can be received by the player terminal 1, the player information at least including the numbers of clears within the period (S2-10).

Referring back to FIG. 13, upon receiving the reward information indicating the rewards determined through the reward lottery process, the player terminal 1 displays a reward screen on the display 26 (P7), and executes quest end processing for normally bringing the quest to an end (P8). Furthermore, here, the player information in the player-information storage unit 94 is updated on the basis of the player information received from the server 100. Note that in P8, there are cases where the numbers of clears within the period are updated at the player terminal 1. Although not shown, in the case where the numbers of clears within the period are updated, the list generation unit 90a updates the list on the basis of the updated numbers of clears within the period.

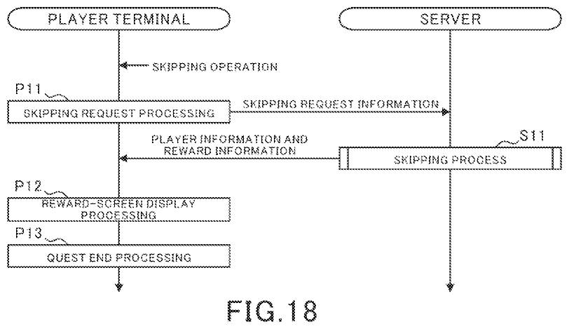

FIG. 18 is a second sequence chart at the player terminal 1 and the server 100. At the player terminal 1, after a quest is selected in the group selection screen, when solo-play is selected as the play mode in the play-mode selection screen (see FIG. 4C), and a skipping operation (tapping of the skip button 35c) is input in the party selection screen (see FIG. 4D), the skipping execution unit 92a executes skipping request processing (P11).

In the skipping request processing, skipping request information is transmitted to the server 100, the skipping request information including the kind of quest, the play mode, and the party information selected by the player. At the server 100, upon receiving the skipping request information, a skipping process is executed (S11).

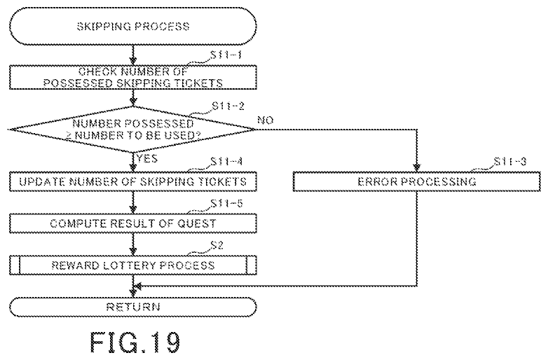

FIG. 19 is a flowchart for explaining the skipping process at the server 100. The skipping execution unit 132a of the server 100 checks the number of possessed skipping tickets of the relevant player, stored in the player-information storage unit 140 (S11-1). Furthermore, in the case where the number possessed is not greater than or equal to the number to be used (NO in S11-2), the skipping execution unit 132a executes prescribed error processing (S11-3).

Note that the number of skipping tickets possessed by the player is also stored in the player-information storage unit 94 of the player terminal 1. In the party selection screen, control is performed so as not to allow the operation of the skip button 35c in the case where the number of skipping tickets possessed by the player is less than the number to be used. However, as a result of a certain problem, skipping request information might be transmitted from the player terminal 1 to the server 100 even though the number of skipping tickets possessed is less than the number to be used. In such cases, prescribed error processing is executed at the server 100, and a skip play is not executed.

In the case where the number of skipping tickets possessed is greater than or equal to the number to be used (YES in S11-2), the player-information update unit 130a subtracts the number to be used from the number of possessed skipping tickets of the relevant player, stored in the player-information storage unit 140 (S11-4). Furthermore, the skipping execution unit 132a computes the result of the quest (S11-5). Furthermore, the reward giving unit 131a executes the reward lottery process (S2), similarly to the above.

Referring back to FIG. 18, upon receiving reward information indicating the rewards determined through the reward lottery process (S2) in the skipping process (S11), the player terminal 1 displays a reward screen on the display 26 (P12), and executes quest end processing for normally bringing the quest to an end (P13). Also here, similarly to P8 described above, the player information in the player-information storage unit 94 is updated on the basis of the player information received from the server 100. The player information that the player terminal 1 receives from the server 100 in the case where the skipping process (S11) is executed includes the number of skipping tickets possessed. Thus, the number of skipping tickets possessed is synchronized between the player terminal 1 and the server 100.

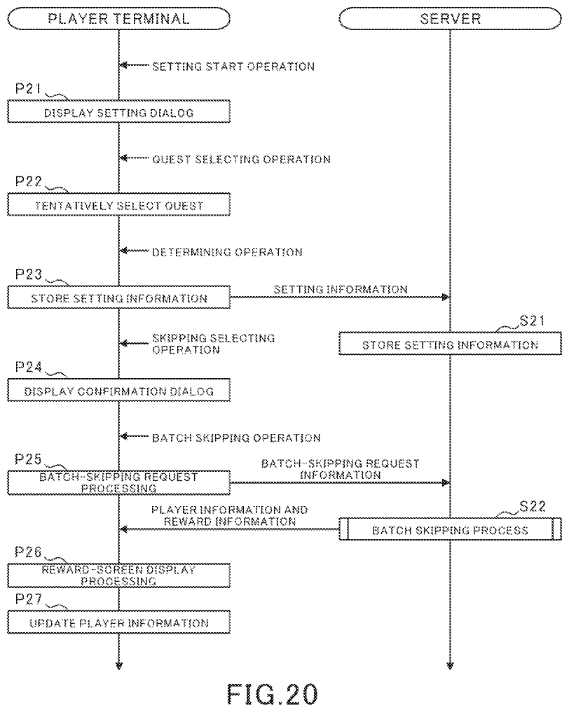

FIG. 20 is a third sequence chart at the player terminal 1 and the server 100. At the player terminal 1, when a setting start operation (tapping of the batch skipping icon 37) is input in the group selection screen, the batch-skipping execution unit 93a displays the batch-skipping-function setting dialog 60 (P21). Here, the batch-skipping execution unit 93a displays the batch-skipping-function setting dialog 60 on the basis of the list saved in the player-information storage unit 94 and the setting information registered by the player in the past.

Furthermore, when a quest selecting operation (tapping of an attribute designating tab and a difficulty-level designating tab) is input in the batch-skipping-function setting dialog 60, the batch-skipping execution unit 93a temporarily saves the selected quest as being tentatively selected (P22).

Furthermore, when a determining operation (tapping of the OK button 70b) is input in the batch-skipping-function setting dialog 60, the batch-skipping execution unit 93a saves the quest saved as being tentatively selected in the player-information storage unit 94 as setting information (P23). The setting information saved in the player-information storage unit 94 is transmitted to the server 100. At the server 100, the player-information update unit 130a stores the received setting information in the player-information storage unit 140 (S21).

Furthermore, when a skipping selecting operation (tapping of the skip button 35c) is input in the party selection screen that is displayed after the input of a determining operation, the batch-skipping execution unit 93a displays the ticket-use confirmation dialog 80 (P24).

Furthermore, when a batch skipping operation (tapping of the batch-skipping start button 80b) is input in the ticket-use confirmation dialog 80, the batch-skipping execution unit 93a executes batch-skipping request processing (P25). Here, batch-skipping request information is transmitted to the server 100.

At the server 100, upon receiving the batch-skipping request information, the batch-skipping execution unit 133a executes a batch-skipping process (S22).

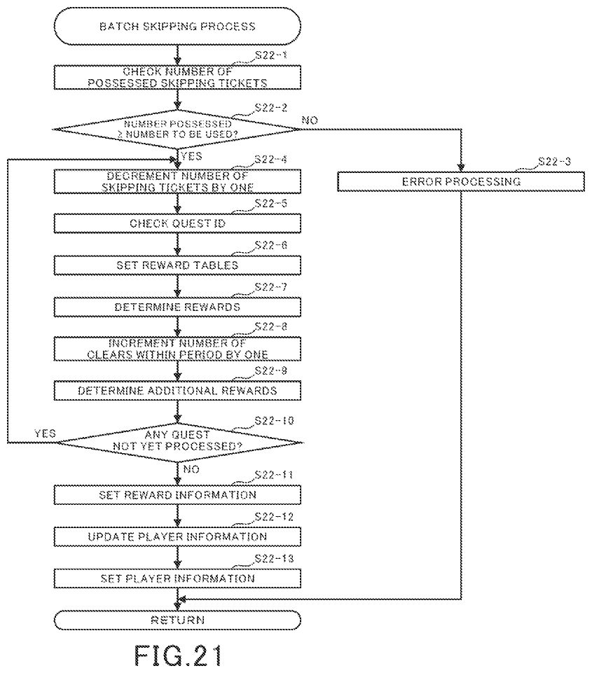

FIG. 21 is a flowchart for explaining the batch skipping process at the server 100. The batch-skipping execution unit 133a of the server 100 checks the number of skipping tickets possessed by the relevant player, stored in the player-information storage unit 140 (S22-1). Furthermore, in the case where the number possessed is not greater than or equal to the number to be used (NO in S22-2), the batch-skipping execution unit 133a executes prescribed error processing (S22-3). This error processing is the same as that in S11-3 described above.

In the case where the number of skipping tickets possessed is greater than or equal to the number to be used (YES in S22-2), the player-information update unit 130a subtracts “1” from the number of skipping tickets possessed by the relevant player, stored in the player-information storage unit 140 (S22-4). Furthermore, the reward giving unit 131a of the server 100 checks the kind of quest, i.e., the quest ID, of the quest selected by the player (S22-5). The reward giving unit 131a sets reward tables corresponding to the kind of quest (S22-6), and determines rewards to be given to the player (S22-7). Here, normal rewards that are given to the player as a result of clearing the quest are determined.

Furthermore, the player-information update unit 130a increments the number of clears within the period, stored in the player-information storage unit 140, by “1” (S22-8). Furthermore, the reward giving unit 131a determines additional rewards (S22-9). Here, the additional rewards are determined on the basis of the quest cleared or the group into which the quest cleared is classified.

Furthermore, in the case where there is any quest that has not yet been processed (YES in S22-10), the batch-skipping execution unit 133a executes the processing in S22-4 to S22-9 above for the quest that has not yet been processed among the quests set by the player as the subjects of the batch skipping process. When the processing is finished for all the quests (NO in S22-10), the reward giving unit 131a sets reward information so that the reward information can be received by the player terminal 1, the reward information indicating the kinds and numbers of rewards determined in S22-7 and S22-9 (S22-11).

Furthermore, the player-information update unit 130a updates the determined number, etc. of rewards in the player-information storage unit 140 on the basis of the rewards determined in S22-7 and S22-9 (S22-12). Thus, rewards are given to the player. Furthermore, the player-information update unit 130a sets prescribed player information so that the player information can be received by the player terminal 1, the player information at least including the numbers of clears within the period and the number of skipping tickets possessed (S22-13). As described above, the batch skipping process (S22) is a process in which a plurality of missions extracted in the list are executed via a skip play.

As described above, according to this embodiment, a plurality of quests are designated as constituting daily missions, and additional rewards are given when one of the quests designated as constituting daily missions is cleared. At this time, a list is generated by extracting quests with which additional rewards have not been acquired yet. Furthermore, it becomes possible to execute the batch skipping process on the basis of the generated list. This simplifies player operations, which makes it possible to enhance the motivation for playing.

Although an aspect of an embodiment has been described above with reference to the accompanying drawings, it goes without saying that the present invention is not limited to the embodiment described above. It would be obvious that a person skilled in the art could conceive of various kinds of modifications or improvements within the scope recited in the claims, and it would be understood that those modifications and improvements obviously fall within the technical scope of the present invention.

In the embodiment described above, the sharing of processes that are executed at the player terminal 1 and the server 100 is merely an example. It suffices for each of the processes described above to be executed by at least one of the player terminal 1 and the server 100, and there is no particular limitation as to the execution timing and executing device therefor.

As an example, in the embodiment described above, the server 100 carries out the process of resetting the numbers of clears within the period to enable the acquisition of additional rewards within the prescribed period, as well as the process of giving additional rewards to the player, and the player terminal 1 carries out the process of generating a list. Alternatively, however, for example, at least one of the process of resetting the numbers of clears within the period and the process of giving additional rewards may be carried out at the player terminal 1. Furthermore, the process of generating a list may be carried out at the server 100. In this case, the player terminal 1 may receive generated list information from the server 100.

Furthermore, the above embodiment has been described in the context of the case where clearing a quest is set as a mission that is assigned to the player. However, missions that are assigned to the player are not limited to clearing quests. For example, regardless of whether a quest is cleared, playing the quest, attaining a score greater than or equal to a prescribed value in the quest, displaying a prescribed game screen, performing a prescribed operation during an out-game, etc. may be set as missions that are assigned to the player.

Furthermore, for example, suppose that a plurality of missions include clearing quests, as well as performing a certain operation in a prescribed game screen. In this case, for example, the missions of clearing quests may be subjected to the batch skipping process, while prompting the player to perform the operation for the mission of performing the certain operation in the prescribed game screen. For example, after executing the batch skipping process for quests, a transition to a prescribed game screen for accomplishing the remaining missions may take place. In either case, there is no particular limitation to the number and content of missions as long as it is possible to acquire a privilege, within an upper-limit number of times per prescribed period, for each of a plurality of missions that can be accomplished by the player.

Furthermore, in the embodiment described above, the player can acquire additional rewards every day. That is, in the embodiment described above, one day is set as an example of the prescribed period. However, the prescribed period is not limited to one day; for example, the prescribed period may be one hour, one week, or the like. Furthermore, in the embodiment described above, the upper-limit number of times is set to once; alternatively, however, the number of times that the player can acquire additional rewards within the prescribed period may be twice or more. In the case where the number of times that the player can acquire additional rewards is twice or more, for example, it is desirable that the number of times of the execution of quests can be set in the batch-skipping-function setting dialog 60.

Furthermore, the above embodiment has been described in the context of the case where the batch-skipping-function setting dialog 60 is displayed on the basis of a generated list. However, processing based on a generated list is not limited thereto. For example, when reporting that additional rewards have not yet been acquired, quests with which it is possible to acquire additional rewards may be reported to the player on the basis of a generated list. Furthermore, for example, whether or not to give additional rewards upon clearing a quest, i.e., whether or not a quest makes it possible to acquire additional rewards, may be determined on the basis of a generated list. In either case, it suffices to generate a list by extracting missions with which the number of times of the acquisition of a privilege during a prescribed period is less than the upper-limit number of times, and the method of utilizing the list can be chosen as appropriate.

Furthermore, in the embodiment described above, the player can select a normal play and a skip play, in which processing is at least partially omitted compared with the normal play, and missions that can be accomplished both via the normal play and the skip play are included. Furthermore, it is possible to carry out a process of executing a plurality of missions extracted in a list via a skip play. Here, in the embodiment described above, it is possible to execute a plurality of missions extracted in a list, i.e., quests, as a batch. Alternatively, the skipping processing may be executed sequentially one by one for the quests extracted in a list.

Alternatively, for example, a plurality of quests extracted in a list may be executed via a normal play instead of a skip play. In this case, all of the plurality of quests extracted in the list may be executable only via a normal play, or may be executable by selecting a skip play or a normal play on a per-quest basis.

Therefore, in the party selection screen shown in FIG. 10C, the start button 35b may be displayed instead of the skip button 35c or together with the skip button 35c. Alternatively, the skip button 35c or the start button 35b may be provided on a per-quest basis, and the player may be prompted to sequentially execute the plurality of quests extracted in the list.

Furthermore, the above embodiment has been described in the context of the case where the player operates participating characters in a quest. Alternatively, however, the result of a quest may be derived automatically by a computer, for example, on the basis of party information set by the player. In either case, it suffices that a quest selected by the player is executed on the basis of information set by the player or an operation input by the player.

Furthermore, in the embodiment described above, each quest is classified into one of the groups. However, quest groups are not necessary. In this case, for example, the upper-limit number of times that additional rewards can be acquired, as well as the numbers of clears within the period, may be set for the individual kinds of quests, not for the individual groups.

Furthermore, in the embodiment described above, quests have set therefor skipping conditions and releasing conditions. However, skipping conditions and releasing conditions are not necessary. Furthermore, for example, even with a quest that does not satisfy the skipping condition, a skip play may be allowed only in the batch skipping process. Furthermore, even with a quest that does not satisfy the releasing condition, a normal play or a skip play may be allowed only in the batch skipping process.

Furthermore, in the embodiment described above, privileges that can be acquired per prescribed period, i.e., additional rewards, vary among the groups into which quests are classified. Alternatively, however, additional rewards may be the same among some or all of the groups.

Furthermore, in the embodiment described above, whether or not to give additional rewards are determined by checking the number of clears within the period. Alternatively, for example, in the case where the number of times that additional rewards are given during the prescribed period for one group is only once, information indicating that additional rewards have been given may be stored when the additional rewards are given. In this case, whether or not to give additional rewards can be determined by checking this information.

Furthermore, in the embodiment described above, the player terminal 1 and the server 100 include one CPU 10 and one CPU 110 (computer), respectively; however, each of the numbers of the CPUs 10 and 110 provided may be one or more.

Note that an information processing program for executing the processes in the embodiment described above may be stored in a non-transitory computer-readable storage medium and may be provided in the form of the storage medium. Furthermore, a game terminal device including this storage medium may be provided. Alternatively, the embodiment described above may be embodied in the form of an information processing method for realizing the individual functions and the steps shown in the flowcharts.

What is claimed is:

1. A non-transitory computer readable medium storing a program causing a computer to execute:
allowing a player to acquire a privilege within an upper-limit number of times per prescribed period, for each of a plurality of missions that the player can accomplish;
giving, when the player accomplishes one of the plurality of missions and a number of times that the player has acquired the privilege within the prescribed period through the accomplished mission is less than the upper-limit number of times, the privilege to the player; and
generating a list by extracting a plurality of first missions, among the plurality of missions, with which the number of times that the player has acquired the privilege within the prescribed period is less than the upper-limit number of times.

2. The non-transitory computer readable medium according to claim 1, the program further causing the computer to execute:
sequentially executing the plurality of first missions extracted in the list.

3. The non-transitory computer readable medium according to claim 1, wherein each of the plurality of missions can be accomplished selectively via a normal play or a skip play that omits at least a part of processing of each of the plurality of missions,
the program further causing the computer to execute:
executing the plurality of first missions extracted in the list via the skip play.

4. The non-transitory computer readable medium according to claim 1,
wherein the plurality of missions includes clearing a plurality of quests,
each of the plurality of quests is classified into one of a plurality of groups,
the plurality of first missions extracted in the list includes clearing quests classified into the same group, and
the privilege that can be acquired per the prescribed period varies among the plurality of groups.

5. The non-transitory computer readable medium according to claim 2,
wherein the plurality of missions includes clearing a plurality of quests,
each of the plurality of quests is classified into one of a plurality of groups,
the plurality of first missions extracted in the list includes clearing quests classified into the same group, and
the privilege that can be acquired per the prescribed period varies among the plurality of groups.

6. The non-transitory computer readable medium according to claim 3,
wherein the plurality of missions includes clearing a plurality of quests,
each of the plurality of quests is classified into one of a plurality of groups,
the plurality of first missions extracted in the list includes clearing quests classified into the same group, and
the privilege that can be acquired per the prescribed period varies among the plurality of groups.

7. An information processing method that is executed by one or more computers, the information processing method comprising:
allowing a player to acquire a privilege within an upper-limit number of times per prescribed period, for each of a plurality of missions that the player can accomplish;
giving, when the player accomplishes one of the plurality of missions and a number of times that the player has acquired the privilege within the prescribed period through the accomplished mission is less than the upper-limit number of times, the privilege to the player; and
generating a list by extracting a plurality of first missions, among the plurality of missions, with which the number of times that the player has acquired the privilege within the prescribed period is less than the upper-limit number of times.

8. An information processing system comprising one or more computers,
wherein the one or more computers execute:
allowing a player to acquire a privilege within an upper-limit number of times per prescribed period, for each of a plurality of missions that the player can accomplish;
giving, when the player accomplishes one of the plurality of missions and a number of times that the player has acquired the privilege within the prescribed period through the accomplished mission is less than the upper-limit number of times, the privilege to the player; and
generating a list by extracting a plurality of first missions, among the plurality of missions, with which the number of times that the player has acquired the privilege within the prescribed period is less than the upper-limit number of times.
